(19) United States
(12) Patent Application Publication
(10) Pub. No.: US 2019/0266301 A1
(43) Pub. Date: Aug. 29, 2019

(54) AN IMPROVED COMPUTATIONAL ELECTROMAGNETICS PROCESS AND SYSTEM

(71) Applicant: THE UNIVERSITY OF QUEENSLAND, St Lucia, Queensland (AU)

(72) Inventors: Amin ABBOSH, St Lucia, Queensland (AU); Arman AFSARI, St. Lucia, Queensland (AU)

(21) Appl. No.: 16/307,919

(22) PCT Filed: Jun. 7, 2017
(86) PCT No.: PCT/AU2017/050568

§ 371 Date: Dec. 6, 2018

(30) Foreign Application Priority Data
Jun. 7, 2016 (AU) 2016902221
Mar. 8, 2017 (AU) 2017900803

(51) Int. Cl. G06F 17/50

(52) U.S. Cl. CPC G06F 17/5018; G06F 17/13

(57) ABSTRACT

A computational electromagnetics system has a memory and at least one processor configured to execute a computational electromagnetics process. The process includes solving a pair of differential equations for only two variables, the two variables representing a pair of scalar potentials, and determining at least one of an electric field and a magnetic field from the pair of scalar potentials.

### TECHNICAL FIELD

The present invention relates to an improved computational electromagnetics process and system, in particular to a more efficient process for generating numerical solutions to problems in electromagnetics defined by partial differential equations.

### BACKGROUND

Computational electromagnetics plays a paramount role in the modeling and understanding of electromagnetic phenomena, and generally involves accurately modeling electromagnetic problems through robust numerical methods. Computational electromagnetics methods are used to calculate electromagnetic fields for a wide array of different applications, including not only the design of many types of physical apparatus, including for example integrated circuits, aircraft, wireless systems, telecommunications and radar systems, but also for advanced medical imaging, diagnosis and treatment methods such as detecting and treating (hyperthermia) tumors, for example. In many of these applications (e.g., microwave-based imaging, radar beamforming or tomography), there is a general need to reduce the calculation time as much as possible.

The most popular and efficient computational electromagnetics methods are finite difference methods (FDM), finite element methods (FEM), moment methods (MOM) and meshless methods, and state of the art commercial software packages, such as HFSS, CST MS, ADS, COMSOL, XFdtd and OmniSim FDTD, are based on one or more of those computational methods.

Despite the considerable power of existing computational electromagnetics methods in their ability to generate accurate solutions to electromagnetic problems, a continuing difficulty of these methods is the substantial (real and processor) time required to generate accurate solutions to the underlying partial differential equations. One approach to reducing the (wall clock) time required to generate solutions to complex computational electromagnetics problems is to use a supercomputer. For example, the Computational Electromagnetics Laboratory of NASA provides access to a computer cluster with 476 processors and 1.95 TB of random access memory dedicated to computational electromagnetics. Nevertheless, several days of computation may be required to simulate the effect of electromagnetic fields on a large scale structure such as an aircraft.

Consequently, there is a general desire or need to reduce the computation times as much as practically possible, and for some applications (e.g., ‘real-time’ imaging and monitoring) there would be distinct advantages if such calculations could be performed in times approaching ‘real-time’, where the delays are in substance negligible.

In view of the above, many attempts have been made to increase the time-efficiency of the aforementioned classical methods. However, despite these ongoing efforts, even today's state of the art methods still require inconveniently long times to generate solutions to electromagnetic problems, especially in the case of large scale problems.

It is desired, therefore, to address or alleviate one or more difficulties of the prior art, or to at least provide a useful alternative.

### SUMMARY

In accordance with some embodiments of the present invention, there is provided a computational electromagnetics process for determining electromagnetic fields, the process being executed by at least one processor of a data processing system, and including the steps of:
(i) solving a pair of differential equations for only two variables, the two variables representing a pair of scalar potentials; and
(ii) determining at least one of an electric field and a magnetic field from the pair of scalar potentials determined at step (i).

In some embodiments, step (ii) includes at least one of:
(iii) determining the electric field \vec{E} according to:

\vec{E}=jωψ∇φ; and
(iv) determining the magnetic field \vec{B} according to:
where φ and ψ represent the scalar potentials, ω represents angular frequency, and j=\sqrt{−1}.

In some embodiments, the differential equations are of the form:

∇²ψ+k²ψ=0

∇²φ=0
where k=ω\sqrt{εμ} is the wavenumber, ε represents permittivity, and μ represents permeability.

In some embodiments, the differential equations are of the form:

∇²ψ+k²ψ=0

∇²v+k²v=0
where k=ω\sqrt{ωμ} is the wavenumber, ε represents permittivity, μ represents permeability, and v represents scalar electric potential, and wherein

$$v = - \frac{j ωϕψ}{2} .$$

In some embodiments, the differential equations are of the form:

$${∇}^{2} ψ + ( 2 {k}^{2} - {γ}^{2} ) ψ = 0$$

$${∇}^{2} ϕ - {γ}^{2} ϕ = 0$$

$$or$$

$${∇}^{2} ψ + ( 2 {k}^{2} - {γ}^{2} ) ψ = 0$$

$${∇}^{2} v + {k}^{2} v = - \frac{ρ + {ρ}_{J}}{ɛ}$$

where φ and ψ represent the scalar potentials,

$$γ = - \frac{j}{2} k ,$$

k=ω\sqrt{εμ} wavenumber, ε represents permittivity, μ represents permeability, v represents scalar electric potential, and v=−jωφψ.

In accordance with some embodiments of the present invention, there is provided a computational electromagnetics process executed by at least one processor of a data processing system, the process including at least one of:
determining an electric field \vec{E} according to:

\vec{E}=jωψ∇φ; and
(ii) determining a magnetic field \vec{B} according to:

\vec{B}∇φ×∇ψ;
where ω represents angular frequency, j=\sqrt{−1}, and φ and ψ represent scalar potentials satisfying a pair of differential equations for only two variables, the two variables representing the scalar potentials.

In some embodiments, the pair of differential equations are of the form:

∇²ψ+k²ψ=0

∇²φ=0
where k=ω\sqrt{εμ} is the wavenumber, ε represents permittivity, and μ represents permeability.

In some embodiments, the pair of differential equations are of the form:

∇²ψ+k²ψ=0

∇²v+k²v=0
where k=ω\sqrt{εμ} is the wavenumber, ε represents permittivity, μ represents permeability, and v represents scalar electric potential, and wherein

$$v = - \frac{j ωϕψ}{2} .$$

In some embodiments, the pair of differential equations are of the form:

$${∇}^{2} ψ + ( 2 {k}^{2} - {γ}^{2} ) ψ = 0$$

$${∇}^{2} ϕ - {γ}^{2} ϕ = 0$$

$$or$$

$${∇}^{2} ψ + ( 2 {k}^{2} - {γ}^{2} ) ψ = 0$$

$${∇}^{2} v + {k}^{2} v = - \frac{ρ + {ρ}_{J}}{ɛ}$$

where k=ω\sqrt{εμ} is the wavenumber,

$$γ = - \frac{j}{2} k ,$$

ε represents permittivity, μ represents permeability, v represents scalar electric potential, and v=−jωφψ.

In accordance with some embodiments of the present invention, there is provided at least one computer-readable storage medium having stored thereon executable instructions that, when executed by at least one processor of a data processing system, cause the at least one processor to execute the computational electromagnetics process of any one of the above processes.

In accordance with some embodiments of the present invention, there is provided at least one computer-readable storage medium having stored thereon executable instructions that, when executed by at least one processor of a data processing system, cause the at least one processor to execute a computational electromagnetics process, including the steps of:
(i) solving a pair of differential equations for only two variables, the two variables representing a pair of scalar potentials; and
(ii) determining at least one of an electric field and a magnetic field from the pair of scalar potentials determined at step (i).

In some embodiments, step (ii) includes at least one of:
(iii) determining the electric field E according to:

\vec{E}=jωψ∇φ; and
(iv) determining the magnetic field \vec{B} according to:

\vec{B}=∇φ×∇ψ;
where φ and ψ represent the scalar potentials, ω represents angular frequency, and j=\sqrt{−1}.

In some embodiments, the differential equations are of the form:

∇²ψ+k²ψ=0

∇²φ=0
where k=ω\sqrt{εμ} is the wavenumber, ε represents permittivity, and μ represents permeability.

In some embodiments, the differential equations are of the form:

∇²ψ+k²ψ=0

∇²v+k²v=0
where k=ω\sqrt{εμ} is the wavenumber, ε represents permittivity, μ represents permeability, and v represents scalar electric potential, and wherein

$$v = - \frac{j ωϕψ}{2} .$$

In some embodiments, the differential equations are of the form:

$${∇}^{2} ψ + ( 2 {k}^{2} - {γ}^{2} ) ψ = 0$$

$${∇}^{2} ϕ - {γ}^{2} ϕ = 0$$

$$or$$

$${∇}^{2} ψ + ( 2 {k}^{2} - {γ}^{2} ) ψ = 0$$

$${∇}^{2} v + {k}^{2} v = - \frac{ρ + {ρ}_{J}}{ɛ}$$

where φ and ψ represent the scalar potentials,

$$γ = - \frac{j}{2} k ,$$

k=ω\sqrt{εμ} is the wavenumber, ε represents permittivity, μ represents permeability, v represents scalar electric potential, and v=−jωφψ.

In accordance with some embodiments of the present invention, there is provided a computational electromagnetics system having a memory and at least one processor configured to execute a computational electromagnetics process, including the steps of:
(i) solving a pair of differential equations for only two variables, the two variables representing a pair of scalar potentials; and
(ii) determining at least one of an electric field and a magnetic field from the pair of scalar potentials determined at step (i).

In some embodiments, step (ii) includes at least one of:
(iii) determining the electric field \vec{E} according to:

\vec{E}=jωψ∇φ; and
(iv) determining the magnetic field \vec{B} according to:

\vec{B}=∇φ×∇ψ;
where φ and ψ represent the scalar potentials, ω represents angular frequency, and j=\sqrt{−1}.

In some embodiments, the differential equations are of the form:

∇²ψ+k²ψ=0

∇²φ=0
where k=ω\sqrt{εμ} is the wavenumber, ε represents permittivity, and μ represents permeability.

In some embodiments, the differential equations are of the form:

∇²ψ+k²ψ=0

∇²v+k²v=0
where k=ω\sqrt{εμ} is the wavenumber, ε represents permittivity, μ represents permeability, and v represents scalar electric potential, and wherein

$$v = - \frac{j ωϕψ}{2} .$$

In some embodiments, the differential equations are of the form:

$${∇}^{2} ψ + ( 2 {k}^{2} - {γ}^{2} ) ψ = 0$$

$${∇}^{2} ϕ - {γ}^{2} ϕ = 0$$

$$or$$

$${∇}^{2} ψ + ( 2 {k}^{2} - {γ}^{2} ) ψ = 0$$

$${∇}^{2} v + {k}^{2} v = - \frac{ρ + {ρ}_{J}}{ɛ}$$

where φ and ψ represent the scalar potentials,

$$γ = - \frac{j}{2} k ,$$

k=ω\sqrt{εμ} is the wavenumber, ε represents permittivity, μ represents permeability, v represents scalar electric potential, and v=−jωφψ.

In accordance with some embodiments of the present invention, there is provided a computational electromagnetics process for determining electromagnetic fields, the process being executed by at least one processor of a data processing system, and including the steps of:
(i) solving a pair of differential equations for only two variables, the two variables representing a pair of scalar potentials; and
(ii) determining at least one of an electric field and a magnetic field from the pair of scalar potentials determined at step (i);

wherein the differential equations are forms of the Schrödinger equation of quantum physics.

The differential equations may be of the form:

∇²ψ+k²ψ=0

∇²φ=0

where φ and ψ are scalar variables;

and wherein step (ii) includes at least one of:
(iii) determining an electric field according to:

\vec{E}=jωψ∇φ; and
(iv) determining a magnetic field according to:

\vec{B}∇φ×∇ψ;
where ω represents angular frequency, and j=\sqrt{−1}.

In accordance with some embodiments of the present invention, there is provided a computational electromagnetics process executed by at least one processor of a data processing system, the process including at least one of:
(i) determining an electric field according to:

\vec{E}=jωψ∇φ; and
(ii) determining a magnetic field according to:

\vec{B}=∇φ×∇ψ;
where ω represents angular frequency, j=\sqrt{−1}, and φ and ψ are scalar variables satisfying:

∇²ψ+k²ψ=0

∇²φ=0

In accordance with some embodiments of the present invention, there is provided at least one computer-readable storage medium having stored thereon executable instructions that, when executed by at least one processor of a data processing system, cause the at least one processor to execute a computational electromagnetics process, including at least one of:
(i) determining an electric field according to:

\vec{E}=jωψ∇φ; and
(ii) determining a magnetic field according to:

\vec{B}=∇φ×∇ψ;
where ω represents angular frequency, j=\sqrt{−1}, and φ and ψ are scalar variables satisfying:

∇²ψ+k²ψ=0

∇²φ=0

In accordance with some embodiments of the present invention, there is provided a computational electromagnetics system having a memory and at least one processor configured to execute a computational electromagnetics process, including at least one of:
(i) determining an electric field according to:

\vec{E}=jωψ∇φ; and
(ii) determining a magnetic field according to:

\vec{B}=∇φ×∇ψ;
where ω represents angular frequency, j=\sqrt{−1}, and φ and ψ are scalar variables satisfying:

∇²ψ+k²ψ=0

∇²φ=0

### BRIEF DESCRIPTION OF THE DRAWINGS

Some embodiments of the present invention are hereinafter described, by way of example only, with reference to the accompanying drawings, wherein:

FIG. 1 is a block diagram of a computational electromagnetics system in accordance with an embodiment of the present invention;

FIG. 2 is a flow diagram of a computational electromagnetics process executed by the computational electromagnetics system;

FIG. 3(a) is a representation of a simple dipole antenna operating at a frequency of 1 GHz;

FIG. 3(b) is a corresponding set of three colour representations of the polar distributions of electric potential (voltage) in the xy-plane (left), yz-plane (middle) and the zx-plane (right);

FIG. 3(c) is a corresponding set of three colour representations of the polar distributions of the norm of the scalar potential yi in the xy-plane (left), yz-plane (middle) and the zx-plane (right);

FIGS. 3(d) to (g) are corresponding pairs of colour plots representing the simulated normalized electric ((d), (e)) and magnetic ((f), (g)) field radiation patterns generated by the dipole antenna of FIG. 3(a) operating at 1 GHz, as simulated using the classical (plots (d), (f)) and two scalar potential (plots (e), (g)) methods in the xy-plane (wave front, top row), the yz-plane (H-plane, middle row), and zx-plane (E-plane, bottom row);

FIG. 4(a) shows a spherical scatterer arranged in front of the dipole antenna of FIG. 3(a);

FIG. 4(b) is a corresponding set of three colour representations of the polar distributions of electric potential (voltage) in the xy-plane (left), yz-plane (middle) and the zx-plane (right);

FIG. 4(c) is a corresponding set of three colour representations of the polar distributions of the norm of the scalar potential yi in the xy-plane (left), yz-plane (middle) and the zx-plane (right);

FIGS. 4(d) to (g) are corresponding pairs of colour plots representing the simulated normalized electric ((d), (e)) and magnetic ((f), (g)) field radiation patterns generated by the dipole antenna of FIG. 3(a) operating at 1 GHz, as simulated using the classical (plots (d), (f)) and two scalar potential (plots (e), (g)) methods in the xy-plane (wave front, top row), the yz-plane (H-plane, middle row), and zx-plane (E-plane, bottom row);

FIG. 5(a) shows eight antennas identical to the dipole antenna of FIG. 3(a) arranged about a model of a human head (see text for details);

FIG. 5(b) is a corresponding set of three colour representations of the polar distributions of electric potential (voltage) in the xy-plane (left), yz-plane (middle) and the zx-plane (right);

FIG. 5(c) is a corresponding set of three colour representations of the polar distributions of the norm of the scalar potential yz in the xy-plane (left), yz-plane (middle) and the zx-plane (right);

FIGS. 5(d) to (g) are corresponding pairs of colour plots representing the simulated normalized electric ((d), (e)) and magnetic ((f), (g)) field radiation patterns generated by the dipole antenna of FIG. 3(a) operating at 1 GHz, as simulated using the classical (plots (d), (f)) and two scalar potential (plots (e), (g)) methods in the xy-plane (wave front, top row), the yz-plane (H-plane, middle row), and zx-plane (E-plane, bottom row).

### DETAILED DESCRIPTION

As known by those skilled in the art, existing computational electromagnetics processes and systems all solve the governing partial differential equations of electromagnetic problems using the auxiliary scalar potential v and vector electromagnetic potential \vec{A}. The electric and magnetic fields in general structures are then calculated according to these four variables (\vec{A} being a vector with 3 spatial components or ‘variables’). In source-free problems (e.g., cavities), the electric field and the magnetic field are each directly derived using the above methods by solving a 3-variable field problem (electric and magnetic fields being vectors with three spatial components each). Although these approaches are able to generate accurate results, the computational resources required are undesirably high.

The described embodiments of the present invention constitute a substantial advance over the prior art by providing a fundamentally new approach to solving computational electromagnetics (EM), requiring only two variables and significantly reducing the computational resources required to generate accurate solutions to electromagnetic problems (e.g., around 70% reduction in computation time).

As known by those skilled in the art, electromagnetic theory is governed by the four Maxwell equations, together with the continuity condition as the fifth equation. In general, those equations are usually solved for any EM problem to find the electric field (\vec{E}) and magnetic flux density (\vec{B}) It is difficult to directly calculate, in an analytical or numerical way, \vec{E} and \vec{B} due to their complex vector representation in Maxwell equations. For example, in the case of isotropic and homogeneous media:

$$∇ \times \vec{E} = - j ω \vec{B} \\ ∇ \times \vec{B} = μ \vec{J} + j ωɛμ \vec{E} \\ ∇ \cdot \vec{E} = \frac{ρ}{ɛ} \\ ∇ \cdot B = 0 \qquad ( 1 )$$

where ε, μ, \vec{J} and ρ are permittivity, permeability, angular frequency, free volumetric electric current and charge densities, respectively, and j=\sqrt{−1} (noting that in the frequency domain of time-harmonic fields,

$$\frac{\partial }{\partial t} \to j ω ) .$$

This difficulty in direct calculation comes from the measurable EM sources i.e. ρ and \vec{J} which do not give \vec{E} and \vec{B} in a straightforward manner through the following decoupled equations for \vec{E} and \vec{B} derived from (1):

$$\begin{matrix}{∇}^{2} {E}_{i} + {k}^{2} {E}_{i} = j ω μ {J}_{i} + {( ∇ ( \frac{ρ}{ɛ} ) )}_{i} ⇒ i = x , y , z \\ boundary conditions \text{:} \{ \begin{matrix}{E}_{t}^{-} = {E}_{t}^{+} \\ {ɛ}_{r}^{-} {E}_{n}^{-} - {ɛ}_{r}^{+} {E}_{n}^{+} = \frac{{ρ}_{s}}{{ɛ}_{0}}\end{matrix} & ( 2 a ) \\ {∇}^{2} {B}_{i} + {k}^{2} {B}_{i} = \frac{- 1}{j ωɛ} {μ ( ∇ \times J )}_{i} ⇒ i = x , y , z \\ boundary conditions \text{:} \{ \begin{matrix}\frac{{B}_{t}^{-}}{{μ}_{r}^{-}} \frac{{B}_{t}^{+}}{{μ}_{r}^{+}} = {μ}_{0} {J}_{s} \\ {B}_{n}^{-} = {B}_{n}^{+}\end{matrix} & ( 2 b )\end{matrix}$$

where the superscripts “+” and “−” denote the corresponding quantity right after and right before the boundary, respectively, ρₛ and Jₛ are the surface charge and current densities, t and n stand for the tangential and normal directions, and k=ω\sqrt{εμ} is the wave number. The vector derivatives of measurable EM sources that appear in equations (2a) and (2b) make them difficult to solve directly, although they are still solvable at the expense of increased computational time in calculating the vector derivatives. The Finite-Difference Time-Domain method (“FDTD”), on the other hand, directly deals with Equation (1), utilizing the Yee method to avoid the difficulties in Equation (2). However, as the FDTD deals with the coupled equations, it must simultaneously solve 6 field components, three magnetic and three electric ones (instead of the 3 field components in Equation (2)).

To overcome the above difficulty, the fields can be indirectly calculated by defining two ‘auxiliary’ potentials, v and \vec{A}, as the scalar electric potential and the vector magnetic potential, respectively, forming a set of four variables (Aₓ, A_{y}, A_{z}, v) that can be directly determined via EM measurable quantities (not their vector derivatives) as

$${∇}^{2} {A}_{i} + {k}^{2} {A}_{i} = μ {J}_{i} ⇒ i = x , y , z \\ {∇}^{2} v + {k}^{2} v = - \frac{ρ}{ɛ} \qquad ( 3 a )$$

and the corresponding boundary conditions as follows (more details about these boundary conditions can be found in Appendix I):

$$\{ \begin{matrix}third kind on truncating boundaries \text{:} \{ \begin{matrix}n \cdot ∇ v + qv \approx 0 \\ n \cdot ∇ {A}_{i} + p {A}_{i} \approx 0\end{matrix} \\ continuity on dielectrics \text{:} \{ \begin{matrix}{v}^{-} = {v}^{+} \& {ɛ}_{r}^{-} \frac{\partial {v}^{-}}{\partial n} = {ɛ}_{r}^{+} \frac{\partial {v}^{+}}{\partial n} \\ n \times {A}_{i}^{-} = n \times {A}_{i}^{+} \\ \frac{1}{{μ}_{r}^{-}} ( \frac{\partial {A}_{n}^{-}}{\partial i} - \frac{\partial {A}_{i}^{-}}{\partial n} ) = \frac{1}{{μ}_{r}^{+}} ( \frac{\partial {A}_{n}^{-}}{\partial i} - \frac{\partial {A}_{i}^{+}}{\partial n} )\end{matrix} \\ discontinuity on conductors \text{:} \{ \begin{matrix}{ɛ}_{r}^{-} \frac{\partial {v}^{-}}{\partial n} - {ɛ}_{r}^{+} \frac{\partial {v}^{+}}{\partial n} = \frac{{ρ}_{s}}{{ɛ}_{0}} \\ \frac{1}{{μ}_{r}^{-}} ( \frac{\partial {A}_{n}^{-}}{\partial i} - \frac{\partial {A}_{i}^{-}}{\partial n} ) \\ - \frac{1}{{μ}_{r}^{+}} ( \frac{\partial {A}_{n}^{-}}{\partial i} - \frac{\partial {A}_{i}^{+}}{\partial n} ) = {μ}_{0} {J}_{s}\end{matrix} \\ Dirichlet on boundaries with given value \text{:} \{ \begin{matrix}v = f \\ {A}_{i} = {g}_{i}\end{matrix}\end{matrix} \qquad ( 3 b )$$

where ε, and μ, are the relative permittivity and permeability, respectively. The functions f, g, q and p are defined below. The boundary conditions in (3b) are classified in more detail below (with respect to the boundary conditions in (2)) for different boundaries. The electric field and magnetic flux density are then derived from the auxiliary potentials described above as:

\vec{E}=−∇v−jω\vec{A}

\vec{B}=∇×\vec{A} (4)

The boundary conditions in (3b) are fundamental to every EM problem, and are described below.
The Continuity Boundary Condition: As seen in Eq. (4), the electric or magnetic potential cannot be discontinuous, because this would cause their vector derivatives (which are in Eq. (4)) to be infinite, in contradiction with nature. Consequently, the auxiliary potentials are continuous on boundaries; i.e., v⁻=v⁺, Aᵢ⁻=Aᵢ⁺.
The Dirichlet Boundary Condition: There are some boundaries, particularly ports and conductors, on which the potential has a fixed and known value. For example, consider a dipole antenna disposed along a z-axis and excited by a sinusoidal voltage at its port. A sinusoidal voltage distribution is thus formed on the port of the antenna. This boundary condition is known as the Dirichlet condition, and can be described on the antenna port as v=f=V₀ sin(kz), where V₀ is a constant. This voltage applies a surface charge on the antenna

$$\frac{\partial v}{\partial n} = \frac{{ρ}_{s}}{ɛ} ,$$

while the voltage over the antenna conducting surface (not the port) remains constant; i.e., V₀ sin(kz₀), where z₀ is the point in space where the antenna conductor is connected to the port. This remains valid for \vec{A} if the antenna is excited by a sinusoidal current instead of voltage, which results in a magnetic potential at the port of A_{z}=g_{z}=A₀ sin(kz), where A₀ is a constant. The corresponding surface current on the conducting surface of the antenna is

$$\frac{\partial A}{\partial n} = μ {J}_{s} .$$

(Absorbing) Boundary Conditions of the Third Kind: Absorbing or truncating boundary conditions are derived from the asymptotic behavior of potentials at large distances from EM sources. The absorbing boundary condition is used to truncate the computational domain and make it computationally finite in terms of memory demands. This condition can be derived as follows, beginning with the electric potential. At large distances, the electric potential approximately propagates as:

$$v \approx {V}_{0} \frac{{e}^{- jkr}}{r} \\ \to \frac{\partial v}{\partial r} \approx - jk ( {V}_{0} \frac{{e}^{- jkr}}{r} ) - \frac{1}{r} ( {V}_{0} \frac{{e}^{- jkr}}{r} ) \\ \to \frac{\partial v}{\partial r} \approx - jkv - \frac{1}{r} v \\ \to \frac{\partial v}{\partial r} + ( jk + \frac{1}{r} ) v = n \cdot ∇ v + qv \approx 0 \\ \to q = jk + \frac{1}{r} \qquad ( 5 )$$

Hence, the absorbing or truncating boundary condition for electric potential with a specific value for q is derived. The same approach is valid for magnetic potential (this general type of the boundary condition is known in the art as the “third kind” boundary condition). Of course, this boundary condition introduces some error, and there exist more accurate types of absorbing boundary conditions, including some with higher order approximations, or perfectly matched layers, which are not discussed herein.
Boundary Conditions on Normal Derivatives: As a direct conclusion from the electromagnetic boundary conditions on \vec{E} and \vec{B} in Eq. (2), the normal derivatives of electric and magnetic potentials obey a specific condition on boundaries. Since the electromagnetic boundary conditions on normal derivatives of auxiliary potentials are rarely mentioned in the literature and the boundary conditions are mainly described in terms of \vec{E} and \vec{B}, in Appendix I the proof of the boundary conditions on normal derivatives in Eq. (3b) are given.

When the partial differential equations of Eq. (3a) are supplemented by the boundary conditions in Eq. (3b), a unique solution for either v or \vec{A} is guaranteed.

Having described above the equations of the four-potential definition of electromagnetics and their boundary conditions, a computational electromagnetics process using only two potentials in accordance with embodiments of the present invention will now be described.

The continuity equation in electromagnetics establishes that, for time harmonic electromagnetic fields, the current and charge densities are linked together as follows:

∇·J=−jωρ (6)

Consequently, if there is no current in the problem domain, the charge will be zero as well. This ‘source-free’ condition covers an important class of electromagnetic problems, as in many microwave engineering problems, the surface currents and charge densities are key. In source-free electromagnetic problems, Eq. (1) can be rewritten as:

∇×\vec{E}=−jω\vec{B}

∇×\vec{B}=jωεμ\vec{E}

∇·\vec{E}=0

∇·\vec{B}=0 (7)

which, in turn, rewrites Eq. (2) as:

$${∇}^{2} {E}_{i} + {k}^{2} {E}_{i} = 0 ⇒ i = x , y , z \\ boundary conditions \text{:} \{ \begin{matrix}{E}_{t}^{-} = {E}_{t}^{+} \\ {ɛ}_{r}^{-} {E}_{n}^{-} - {ɛ}_{r}^{+} {E}_{n}^{+} = \frac{{ρ}_{s}}{{ɛ}_{0}}\end{matrix} \\ {∇}^{2} {B}_{i} + {k}^{2} {B}_{i} = 0 ⇒ i = x , y , z \\ boundary conditions \text{:} \{ \begin{matrix}\frac{{B}_{t}^{-}}{{μ}_{r}^{-}} \frac{{B}_{t}^{+}}{{μ}_{r}^{+}} = {μ}_{0} {J}_{s} \\ {B}_{n}^{-} = {B}_{n}^{+}\end{matrix} \qquad ( 8 )$$

The source-free equation (8) can still be solved through either of the following two methods. In the first method, the fields are indirectly calculated by solving for the scalar electric and magnetic vector potentials Aₓ, A_{y}, A_{z}, v; i.e.:

∇²Aᵢ+k²Aᵢ=0⇒i=x, y, z

∇²v+k²v=0 (9)

whose boundary conditions are given by Eq. (3b). In this case, the equations of the four potentials must be solved, while there is no source in the problem domain.

Alternatively, the second method involves direct calculation of the main fields (say \vec{E}) containing 3 main components in Eq. (8), and then calculating \vec{B} as

$$\vec{B} = \frac{1}{- j ω} ∇ \times \vec{E} .$$

This second method is the preferred choice, because only the three equations of the main vector fields need to be solved.

Equation (3a) indicates that \vec{A} originates from electric currents. Although Eq. (9) represents a source-free problem, it nevertheless requires solving the magnetic vector potential for the three components Aₓ, A_{y}, A_{z}, and consequently the second of the above methods is preferably used to solve source-free problems because it is computationally less demanding.

In view of the requirement to solve the equations of 3 scalar potentials (Aₓ, A_{y}, A_{z}) in electromagnetic problems originating from \vec{B}=∇×\vec{A}, together with the fact that \vec{B}=∇×\vec{A} is only one of the possible definitions for \vec{B}, the inventors questioned whether \vec{B}=∇×\vec{A} is always the best definition for solving EM problems, or whether there may be cases where it is better (in terms of computation time and possibly also the interpretation of the problem) to use other possible definitions. The inventors explored alternative definitions for \vec{B} and assessed their suitability and practicality for solving EM problems.

The definition of B in Eq. (4) arises from its divergence-free identity (∇·\vec{B}=0), which allows \vec{B} to be defined as any divergence-free ‘auxiliary’ field, and indeed any vector field satisfying the divergence-free property can be considered as a solution for \vec{B}. Recognizing this fact, and in accordance with the described embodiments of the present invention, the magnetic field \vec{B} is defined by two scalar potentials, as follows:

\vec{B}=∇φ×∇ψ (10)

which clearly satisfies the requirement that ∇·\vec{B}=0, and with straightforward vector calculus can be rewritten as:

$$\vec{B} = \frac{1}{2} ∇ \times ( ϕ ∇ ψ - ψ ∇ ϕ ) \qquad ( 11 )$$

Substituting \vec{B} from equation (4) into equation (11) and solving for \vec{A}, yields:

$$\vec{A} = \frac{1}{2} ( ϕ ∇ ψ - ψ ∇ ϕ ) \qquad ( 12 )$$

Although this establishes the relationship between (φ, ψ) and \vec{A}, in order to rewrite both \vec{E} and \vec{B} in Eq. (4) according to this pair of scalar potentials, their relation with the scalar potential v should be determined. To this end, and as the divergence of \vec{A} can be freely defined, a value for ∇ \vec{A} that simplifies the field calculations is utilized. In classical electromagnetics, this value is established according to the following equation, known as the Lorentz gauge condition:

∇·\vec{A}=−jωεμv (13)

The Lorenz gauge condition of Eq. (13) relates the voltage to magnetic potential in an arbitrary manner to simplify the equations. Hence, to find the relation between the pair scalars and the electric potential, the same procedure can be followed by equating the right-hand side of Eq. (13) to an arbitrary term containing the pair potentials. This relation, while arbitrary, does not violate the electromagnetic framework because it still satisfies Maxwell's equations. In the following, two alternative forms of the definition are given to provide two possible solutions.

Definition #1:

In the first possible definition, the right hand side of (13) is defined as follows:

$$∇ \cdot \vec{A} = - \frac{{ω}^{2} ɛμϕψ}{2} \qquad ( 14 )$$

An important point in Eq. (14) is that there is no change in the Lorenz gauge condition, because Eq. (14) is assumed to be an identical representation of Eq. (13), but in terms of the pair potentials. The reason for this specific chosen value is discussed below where it simplifies the governing equations on pair scalar potentials. It follows from equations (13) and (14) that the scalar electric potential v is related to the scalar pair-potentials φ and ψ according to:

$$v = - \frac{j ω}{2} ϕψ \qquad ( 15 )$$

Therefore, the electric field \vec{E} can be rewritten in terms of the pair-potentials by substituting equations (15) and (12) into equation (4) to provide:

\vec{E}=jωψ∇φ (16)

Now that equations (10) and (16) express \vec{E} and \vec{B} in terms of the pair potentials, the governing equations on the pair potentials can be specified to replace the classical auxiliary potential equations on \vec{A} and v. By substituting Eq. (12) in Eq. (14), the governing equation on the scalar potentials is provided as:

$$\frac{1}{ψ} ( {∇}^{2} ψ + {k}^{2} ψ ) = \frac{1}{ϕ} {∇}^{2} ϕ \qquad ( 17 )$$

where k=ω\sqrt{εμ} is the well-known wave number. Equation (17) is still a coupled equation for which the individual identities of φ and ψ are unknown.

In order to solve (17) to find φ and ψ, it must be separated so that either φ or ψ has their own equations. To decouple these potentials, (17) is equated to γ² as an arbitrary value, providing the following separated equations:

∇²ψ+(k²−γ²)ψ=0

∇²φ−γ²φ=0 (18)

To calculate EM fields, these separate equations are solved individually at step 202, and at step 204 their solutions are substituted into equations (10) and (16) to respectively determine the corresponding magnetic and electric fields. However, it should be noted that equation (15) represents the electric potential v in terms of the two scalar potentials φ and ψ. Since the electric potential is a well-known quantity in terms of the boundary conditions, there is no need to calculate both ψ and φ directly, and either one of them, say ψ, can be simply calculated after solving the partial differential equations of v and the other one, say φ, determined as

$$ϕ = - \frac{2 v}{j ωψ} \qquad ( 19 )$$

Equation (19) is a simple division, and its computational time is almost negligible. Therefore, the focus will be only on the first equation in (18). In order to solve the equation of ψ in (18), the value of γ should first be determined. Assuming isotropic and homogeneous media, the wavenumber of EM waves (k) is a scalar. This fact is utilized in Appendix II to prove that the only possible value for γ is γ=0, which shows that φ has a static nature (but clearly with non-trivial solutions, as its Dirichlet boundary conditions are not zero on conductors. Thus, the next step is to find the distribution of ψ.

In order to find the distribution of ψ, its boundary conditions are defined so that a unique solution is guaranteed. The boundary conditions for ψ are derived as follows.
The Continuity Boundary Condition: As seen in (10), the gradient of ψ appears in the equation of \vec{B}. As \vec{B} cannot be infinite anywhere, ψ cannot be discontinuous anywhere. Thus, ψ⁻=ψ⁺ is applies on boundaries.
The Third Kind of Boundary Condition on Tangential Derivatives: from equation (10):

$$\vec{B} = ∇ ϕ \times ∇ ψ = \vert \begin{matrix}\vec{{t}_{1}} & \vec{{t}_{2}} & \vec{n} \\ \frac{\partial ϕ}{\partial {t}_{1}} & \frac{\partial ϕ}{\partial {t}_{2}} & \frac{\partial ϕ}{\partial n} \\ \frac{\partial ψ}{\partial {t}_{1}} & \frac{\partial ψ}{\partial {t}_{2}} & \frac{\partial ψ}{\partial n}\end{matrix} \vert = ( \frac{\partial ϕ}{\partial {t}_{2}} \frac{\partial ψ}{\partial n} - \frac{\partial ϕ}{\partial n} \frac{\partial ψ}{\partial {t}_{2}} ) {\vec{t}}_{1} + ( \frac{\partial ϕ}{\partial n} \frac{\partial ψ}{\partial {t}_{1}} - \frac{\partial ϕ}{\partial {t}_{1}} \frac{\partial ψ}{\partial n} ) {\vec{t}}_{2} + ( \frac{\partial ϕ}{\partial {t}_{1}} \frac{\partial ψ}{\partial {t}_{2}} - \frac{\partial ϕ}{\partial {t}_{2}} \frac{\partial ψ}{\partial {t}_{2}} ) \vec{n} \qquad ( 20 )$$

where t₁, t₂ and n stand for the two tangential components and the normal component in Cartesian coordinates, respectively. Substituting equation (19) into equation (20) gives:

$$\vec{B} = \frac{2}{j ωψ} ( - \frac{\partial v}{\partial {t}_{2}} \frac{\partial ψ}{\partial n} + \frac{\partial v}{\partial n} \frac{\partial ψ}{\partial {t}_{2}} ) {\vec{t}}_{1} + \frac{2}{j ωψ} ( - \frac{\partial v}{\partial n} \frac{\partial ψ}{\partial {t}_{1}} + \frac{\partial v}{\partial {t}_{1}} \frac{\partial ψ}{\partial n} ) {\vec{t}}_{2} + \frac{2}{j ωψ} ( - \frac{\partial v}{\partial {t}_{1}} \frac{\partial ψ}{\partial {t}_{2}} + \frac{\partial v}{\partial {t}_{2}} \frac{\partial ψ}{\partial {t}_{1}} ) \vec{n} \qquad ( 21 )$$

Now, compare this equation with the boundary conditions of the magnetic flux density in electromagnetics. On conductors, the tangential component of the magnetic flux density supports a surface current (e.g., Bₜ_{₁}=μJ, in t₁ direction). Also, the electric voltage is constant across the conductors, resulting in zero tangential component for its gradient

$$( \frac{\partial v}{\partial {t}_{1}} = \frac{\partial v}{\partial {t}_{2}} = 0 ) .$$

These two conditions assign the following tangential boundary condition for ψ on the conductors:

$$\frac{\partial ψ}{\partial {t}_{2}} - ( \frac{j ω μ {J}_{s}}{2 \frac{\partial v}{\partial n}} ) ψ = 0 \qquad ( 22 )$$

Moreover, the normal boundary condition of the electric voltage in equation (3b) means that its normal derivative supports a surface charge on the conductors, as follows:

$$\frac{\partial ψ}{\partial {t}_{2}} - ( \frac{j ωɛμ {J}_{s}}{2 {ρ}_{s}} ) ψ = 0 \qquad ( 23 )$$

The relationship between the surface current density and charge density is Jₛ=jωρₛ. Substituting this relationship into equation (23) finalizes the third kind of boundary condition of ψ over the conductors as:

$$\frac{\partial ψ}{\partial {t}_{2}} + \frac{{k}^{2}}{{\underbrace{2}}_{h}} ψ = 0 \qquad ( 24 )$$

Are equations (16) and (24) in contradiction on conductors? The tangential component of the electric field is always zero on conductors. Therefore, one may incorrectly derive:

\vec{E}ₜ=jωψ∇ₜφ=0 (25)
on the conductors, which leads us toward either of the following (incorrect) conditions on conductors:

ψ=0

or

∇ₜφ=0 (26)

If ψ=0, then equation (19) would cause ϕ to be infinite, in contradiction to the continuity boundary conditions. Conversely, if ∇ₜφ=0, this condition assigns a constant value to both φ=φ₀ and ψ=ψ₀ on conductors. In other words, ∇ₜψ=0 which violates equation (24). Consequently, equation (25) cannot be correct, and indeed this incorrect approach is due to the direct use of equation (16). As shown in Appendix I, on (conducting) boundaries, only the electric potential contributes to derive its normal (or tangential) boundary conditions from the electric fields, and the magnetic potential \vec{A} does not have any contribution (it is canceled in the calculation process). Hence, as equation (16) is based on both \vec{A} and v, its direct use is wrong.
The Third Kind or Absorbing Boundary Condition: Since ψ is a potential function, the same procedure as electric potential is utilized to approximate ψ at far fields. The behavior of ψ at far fields is thus approximated by the following third kind of boundary condition:

$$n \cdot ∇ ψ + \underbrace{( jk + \frac{1}{r} )}_{w} ψ \approx 0 \qquad ( 27 )$$

Consequently, a typical absorbing boundary condition for ψ is derived.
Boundary Conditions on Normal Derivatives: Substituting equation (21) in the tangential boundary conditions of the magnetic flux density in equation (8), the following relation between the normal and tangential derivatives of ψ and the electric voltage on dielectrics is derived:

$$\frac{\partial v}{\partial t} [ \frac{1}{{μ}^{+}} \frac{\partial {ψ}^{+}}{\partial n} - \frac{1}{{μ}^{-}} \frac{\partial {ψ}^{-}}{\partial n} ] = \frac{\partial v}{\partial n} [ \frac{1}{{μ}^{+}} \frac{\partial {ψ}^{+}}{\partial t} - \frac{{ɛ}^{+}}{{ɛ}^{-} {μ}^{-}} \frac{\partial {ψ}^{-}}{\partial t} ] .$$

In this equation, the normal and tangential derivatives are linked together. However, as the normal and tangential directions are perpendicular and thus independent from each other, this equation is equated to zero to apply the tangential and normal derivative boundary conditions, independently. Experimental observations show that the desired electromagnetic fields are derived under the above condition. Applying this condition gives:

$$\frac{1}{{μ}^{+}} \frac{\partial {ψ}^{+}}{\partial n} = \frac{1}{{μ}^{-}} \frac{\partial {ψ}^{-}}{\partial n} , \frac{1}{{μ}^{+} {ɛ}^{+}} \frac{\partial {ψ}^{+}}{\partial t} = \frac{1}{{ɛ}^{-} {μ}^{-}} \frac{\partial {ψ}^{-}}{\partial t} .$$

The above boundary condition thus describes the normal and tangential derivative components of ψ over the dielectric interfaces.

Having derived the boundary conditions for ψ as a new potential, its corresponding equation will provide a unique solution. Consequently, by determining the pair scalar potentials through solving the governing equations on v and ψ supplemented by their boundary conditions, the magnetic flux density and electric field in source-free problems can be calculated according to equations (10) and (16), respectively, using only two scalar potentials (instead of the 4 auxiliary or 3 main components of the prior art).

By way of summary, the governing equations on v and ψ are:

∇²ψ+k²ψ=0

∇²v+k²v=0 (28a)

Since the boundary conditions of the electric potential have already been summarized above in equation (3b), only the boundary conditions of ψ are summarized here as:

$$\{ \begin{matrix}third kind on truncating boundaries \text{:} n \cdot ∇ ψ + w ψ \approx 0 \\ continuity on dielectrics \text{:} \{ \begin{matrix}\frac{1}{{μ}_{r}^{-}} \frac{\partial {ψ}^{-}}{\partial n} = \frac{1}{{μ}_{r}^{+}} \frac{\partial {ψ}^{+}}{\partial n} \\ {ψ}^{-} = {ψ}^{+} \\ \frac{1}{{μ}_{r}^{+} {ɛ}_{r}^{+}} \frac{\partial {ψ}^{+}}{\partial t} = \frac{1}{{ɛ}_{r}^{-} {μ}_{r}^{-}} \frac{\partial {ψ}^{-}}{\partial t}\end{matrix} \\ third kind on conductors \text{:} n \times ∇ ψ + h ψ = 0\end{matrix} \qquad ( 28 b )$$

Definition #2:

The second possible definition is given as:

∇·\vec{A}=−ω²εμφψ (29)

An important point in equation (29) is that there is no change in the Lorenz gauge condition because equation (29) is assumed to be an identical representation of equation (13), but in terms of the pair potentials. This specific form is chosen to simplify the governing equations on the pair scalar potentials, as described below.

Equations (13) and (29) can be used to find the relation between the scalar electric potential v and the scalar pair-potentials φ and ψ as:

v=−jωφψ (30)

Therefore, the electric field \vec{E} can now be rewritten according to the pair-potentials by substituting equations (30) and (12) into equation (4) as:

$$\vec{E} = \frac{j ω}{2} ( ϕ ∇ ψ + 3 ψ ∇ ϕ ) \qquad ( 31 )$$

Thus equations (10) and (31) respectively define the magnetic and electric fields in terms of the pair-scalar potentials. With these definitions, the governing equations on the presented potentials can be specified so that they can replace the classical auxiliary potential equations on \vec{A} and v. By substituting equation (12) in equation (29), the governing equation on the presented potentials is derived as:

$$\frac{1}{ψ} ( {∇}^{2} ψ + 2 {k}^{2} ψ ) = \frac{1}{ϕ} {∇}^{2} ϕ \qquad ( 32 )$$

However, equation (32) is still a coupled equation for φ and ψ. To decouple these potentials, equation (32) is equated to γ² as an arbitrary function leading us towards the following separated equations:

∇²ψ+(2k²−γ²)ψ=0

∇²φ−γ²φ=0 (33)

In practice, these separate equations are solved individually and their solutions substituted into equations (10) and (31) to find the magnetic and electric fields, respectively. However, equation (30) defines the electric potential v as another scalar in terms of φ and ψ. Since the electric potential v is a well-known quantity in terms of sources and boundary conditions, there is no need to calculate both ψ and φ directly. One of them, say φ, can be simply calculated after solving the partial differential equations of v and the other one, say ψ, determined as:

$$ϕ = - \frac{v}{j ωψ} \qquad ( 34 )$$

Clearly, equation (34) is a simple division, and its computational time is therefore almost negligible. Therefore, the focus will be only on the first equation in (33).

The first equation in (33) is an eigenvalue equation with wavenumber \sqrt{2k} and eigenvalue γ. The meaning of this equation is discussed later, after describing the boundary conditions of ψ. The corresponding distribution of ψ for the eigenvalue is called the eigenstate of ψ. In every eigenvalue problem, the first step is to find the eigenvalue itself. Then, the corresponding eigenstates of this eigenvalue are found. Assuming isotropic and homogeneous media, the wavenumber of EM waves (k) is therefore a scalar. This fact is utilized in the Appendix IV to prove that the only possible value for the eigenvalue is

$$γ = - \frac{j}{2} k .$$

Interestingly, if the eigenvalues of ψ are independently derived using FEM, not using the simple approach given in the Appendix IV, the dominant eigenvalue will be

$$γ = - \frac{j}{2} k ,$$

indicating that the two approaches coincide and agree that the higher order eigenvalues are not applicable. Thus, it is only necessary to find the eigenstates of ψ, because the eigenvalue is already known.

To find the eigenstates of ψ, its boundary conditions are defined to guarantee a unique solution. The boundary conditions for it are derived as follows:
The Continuity Condition: As seen in equations (10) and (31), the gradient of it appears in the equations for \vec{E} and \vec{B}. As \vec{E} and \vec{B} cannot be infinite anywhere, ψ cannot be discontinuous anywhere. Thus, ψ⁻=ψ⁺ on boundaries.
The Dirichlet Boundary Condition: In eigenvalue problems, there is no excitation in the problem domain. In other words, the exciting ports are all off. This assigns a zero value ψ it on conductors. The Dirichlet boundary condition on conductors for ψ is thus ψ=h=0 (where h is a symbolic function).
The Absorbing Boundary Condition: The same procedure as electric potential is utilized to approximate ψ at far fields. Obviously, the eigenstates of ψ are standing waves as they are derived from an eigenvalue problem without any excitation term. Since the standing waves do not decay at far fields, their behaviour at far fields is approximated by:

$$ψ \approx {ψ}_{0} {e}^{- j \sqrt{2 {k}^{2} - {γ}^{2}} r} \\ \to \frac{\partial ψ}{\partial n} \approx - j \sqrt{2 {k}^{2} - {γ}^{2}} ψ \\ \to n \cdot ∇ ψ + \underbrace{j \sqrt{2 {k}^{2} - {γ}^{2}}}_{w} ψ \approx 0$$

Consequently, a typical absorbing boundary condition for ψ is derived.
Boundary Conditions on Normal and Tangential Derivatives: Substituting (12) in the normal boundary conditions of the magnetic vector potential in (3b), and then, substituting for φ using (34), the following relation between the normal and tangential derivatives of ψ and voltage on dielectrics is derived:

$$[ \frac{1}{{μ}^{+}} \frac{\partial {ψ}^{+}}{\partial n} - \frac{1}{{μ}^{-}} \frac{\partial {ψ}^{-}}{\partial n} ] = \frac{\frac{\partial v}{\partial n}}{\frac{\partial v}{\partial t}} [ \frac{1}{{μ}^{+}} \frac{\partial {ψ}^{+}}{\partial t} - \frac{{ɛ}^{+}}{{ɛ}^{-} {μ}^{-}} \frac{\partial {ψ}^{-}}{\partial t} ] .$$

In this equation, the normal and tangential derivatives are linked together. However, as the normal and tangential directions are perpendicular and thus independent from each other, the above equation is equated to zero to apply the tangential and normal derivative boundary conditions, separately. Experimental observations show that the desired electromagnetic fields are derived under the above separation. Applying this condition gives:

$$\frac{1}{{μ}^{+}} \frac{\partial {ψ}^{+}}{\partial n} = \frac{1}{{μ}^{-}} \frac{\partial {ψ}^{-}}{\partial n} , \frac{1}{{μ}^{+} {ɛ}^{+}} \frac{\partial {ψ}^{+}}{\partial t} = \frac{1}{{ɛ}^{-} {μ}^{-}} \frac{\partial {ψ}^{-}}{\partial t} .$$

The above boundary condition thus describes the normal and tangential derivative components of ψ over the dielectric interfaces.

The boundary conditions have now been derived for ψ, and hence its corresponding equation will give a unique solution. Because the equation and boundary conditions of ψ are reminiscent of the properties and behaviour of energy density, this is the physical quantity allocated to ψ in this specification.

By way of summary, in order to solve electromagnetic problems, the first step is to determine the pair scalar potentials by solving the governing equations on v and ψ supplemented by their boundary conditions. The magnetic flux density and electric fields are then calculated according to equations (10) and (31), respectively, using only two scalars. The governing equations and boundary conditions on v and ψ are:

$$\begin{matrix}{∇}^{2} ψ + ( 2 {k}^{2} - {γ}^{2} ) ψ = 0 \\ {∇}^{2} v + {k}^{2} v = - \frac{ρ + {ρ}_{J}}{ɛ} & ( 35 a ) \\ \{ \begin{matrix}continuity on dielectrics \text{:} \{ \begin{matrix}{v}^{-} = {v}^{+} \& {ɛ}_{r}^{-} \frac{\partial {v}^{-}}{\partial n} = {ɛ}_{r}^{+} \frac{\partial {v}^{+}}{\partial n} \\ {ψ}^{-} = {ψ}^{+} \\ \frac{1}{{μ}_{r}^{-}} \frac{\partial {ψ}^{-}}{\partial n} = \frac{1}{{μ}_{r}^{+}} \frac{\partial {ψ}^{+}}{\partial n} \\ \frac{1}{{μ}_{r}^{+} {ɛ}_{r}^{+}} \frac{\partial {ψ}^{+}}{\partial t} = \frac{1}{{ɛ}_{r}^{-} {μ}_{r}^{-}} \frac{\partial {ψ}^{-}}{\partial t} \end{matrix} \\ continuity on conductors \text{:} \{ \begin{matrix}{v}^{-} = {v}^{+} \\ {ψ}^{-} = {ψ}^{+}\end{matrix} \\ Dirichlet on boundaries with given value \text{:} \{ \begin{matrix}v = f \\ ψ = h\end{matrix} \\ absorbing on truncating boundaries \text{:} \{ \begin{matrix}n \cdot ∇ v + qv \approx 0 \\ n \cdot ∇ ψ + w ψ \approx 0\end{matrix}\end{matrix} & ( 35 b )\end{matrix}$$

The change in the right-hand side of the equation of voltage i.e. ρ_{J}, is discussed further. As seen in the derived equations (35a), while the charge density contributes in the 2-scalar equations as well as the classical ones, the current density J has disappeared. However, this disappearance does not mean ignoring the effect of current densities. The continuity equation in electromagnetics, i.e.:

∇·J=−jωρ_{J} (36)

tells us that the current and charge densities for time harmonic fields are linked together, and knowing one of them means the other can be determined. Therefore, if there is any current in the problem domain, this current is identical to an equivalent charge of

$${ρ}_{J} = - \frac{1}{j ω} ∇ \cdot J$$

and this charge and other free charges are considered in the second of equations (35a).

In practice, different computational methods can be used to solve the equations above, but the most common of these methods are finite difference and finite element methods. Although these methods are standard methods well known to those skilled in the art, and may be provided, for example, by existing software packages (as they are in the Examples described below), the application of each of these methods to solve electromagnetic problems using the equations described above is briefly described below to illustrate how they are applied in practice. Appendix III discusses the FEM implementation and formulation for numerically solving the electric potential equation and the equation of ψ, respectively.

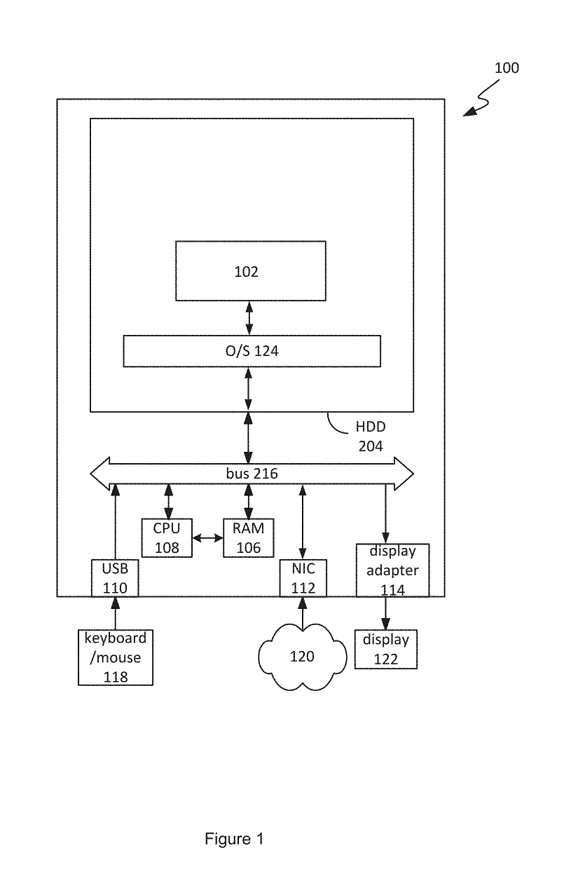

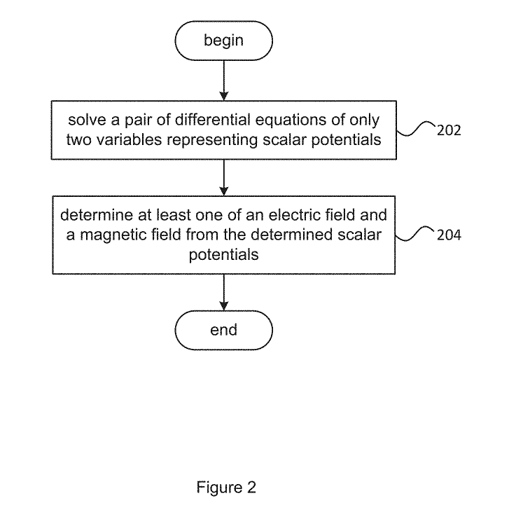

In some embodiments, as shown in FIG. 1, a computational electromagnetics system 100 includes an Intel Architecture computer or data processing system, and executes a computational electromagnetics process as shown in FIG. 2 and described herein, the process being implemented in the form of programming instructions of one or more software modules 102 stored on non-volatile (e.g., hard disk or solid-state drive) storage 104 of or associated with the computer system 100, as shown in FIG. 1, and configured to solve the equations described above, namely either:
(i) equations (18) or (28a) subject to boundary conditions of (3b) and (28b) (if using definition #1); or
(ii) equations (35a) subject to boundary conditions of (3b) and (35b) (if using definition #2),

and in either case then solving equations (10) and (16). However, it will be apparent that the computational electromagnetics process could alternatively be implemented in the form of one or more dedicated hardware components, such as application-specific integrated circuits (ASICs) and/or as configuration data of at least one field programmable gate array (FPGA), for example.

In the embodiment of FIG. 1, the system 100 includes a random access memory (RAM) 106, at least one processor 108, and external interfaces 110, 112, 114, all interconnected by a bus 116. The external interfaces may include universal serial bus (USB) interfaces 110, at least one of which is connected to a keyboard 118 and a pointing device such as a mouse 119, a network interface connector (NIC) 112 which connects the system 100 to a communications network such as the Internet 120, and a display adapter 114, which is connected to a display device such as an LCD panel display 122. The system 100 may also include one or more standard software modules 1 to 130, including an operating system 124 such as Linux or Microsoft Windows, and optionally web server software 126 such as Apache, available at http://www.apache.org. In some embodiments, the computational electromagnetics process described herein can be embedded in a software package for solving general electromagnetics problems, such as any of the state of the art commercial software packages known to those skilled in the art, including HFSS, CST MS, ADS, COMSOL, XFdtd and OmniSim FDTD, which as described above implement one or more of FDM, FEM, MOM, and meshless methods known to those skilled in the art for solving the equations described herein.

The computational electromagnetics process and system described herein enable the simulation of electric and/or magnetic fields in a fraction of the time taken by prior art systems and processes to generate results to the same accuracy and using the same computational hardware. For example, one particular simulation of the safety of an airplane with respect to electromagnetic fields currently takes several days to calculate using existing state of the art methods, whereas the same simulation can be performed in less than a day by the computational electromagnetics system and process described herein. In the biomedical application described below, the simulation described below took several hours using prior art methods, but less than an hour using the computational electromagnetics system and process described herein. Moreover, the improved efficiency of calculation can be even more significant in optimization simulations that may require, for example, hundreds of iterations to complete. For example, a hyperthermia cancer treatment simulation requiring hundreds of iterations of electromagnetic calculations on a patient-specific breast model (to guarantee proper beamforming and focus the energy at the tumor without any hot spots in healthy tissue) took more than a week to calculate using prior art methods on a general purpose personal computer, but was completed in less than a day by the computational electromagnetics process described herein and using the same personal computer. The computational electromagnetics process and system described herein is generally applicable to any source-free problem and to problems with sources having known surface current distributions (which are responsible for generating the electromagnetic fields). Methods for predicting surface current distributions in electromagnetic problems with sources are known to those skilled in the art, including the method described above in the context of boundary conditions.

### EXAMPLES

In order to validate and demonstrate the power of the described methods, several electromagnetic problems were simulated by prior art classical methods and by the new computational electromagnetics process described herein, using the commercial Finite Element Modelling (FEM) software package COMSOL Multiphysics®, as described at https://www.consol.com/comsol-multiphysics.

The COMSOL software package was chosen because it not only provides components configured to solve pre-defined problems in electromagnetics and other subject areas using state of the art classical methods, but also provides an equation-based Mathematics Module modelling component for custom simulations, allowing the powerful COMSOL solvers to be applied to solve essentially any user-defined differential equations and with any kind of boundary conditions in either 1, 2, or 3D domains. (In contrast, other commercial software packages, such as ADS, CST and HFSS are closed packages that do not allow users to solve arbitrary user-defined problems.)

In the following examples, each electromagnetic problem was solved first by classical methods using the Electromagnetic Waves component of COMSOL Multiphysics®, and then by the method described herein using the “Equation-based Modelling” component of COMSOL Multiphysics®. Because qualitative comparisons between these two formulations are difficult (e.g., by comparing the color bars in the figures), the following difference definition was used to quantitatively demonstrate the accuracy of the two-scalar method described herein with respect to the classical solution:

$$Error = \frac{{\sum }_{m} \vert {\vec{E}}_{classical}^{m} - {\vec{E}}_{2 - variable}^{m} \vert}{M {\sum }_{m} \vert {\vec{E}}_{classical}^{m} \vert} + \frac{{\sum }_{m} \vert {\vec{B}}_{classical}^{m} - {\vec{B}}_{2 - variable}^{m} \vert}{M {\sum }_{m} \vert {\vec{B}}_{classical}^{m} \vert} \qquad ( 29 )$$

where m is the element number of FEM discretization, and M is the total number of elements. It should be borne in mind that the classical implementation in COMSOL benefits from physics-based meshing and associated algorithms that have been optimized to tradeoff between accuracy and computational time, whereas the Mathematics Module used for the two-scalar method described herein does not benefit from these optimizations. Consequently, the reductions in computational time described below are effectively under estimates of the improvements that are achievable in practice.

To derive electromagnetic fields using the two-scalar method, the equations in (28) and (35), which give identical results, were solved, whereas COMSOL uses the equations in (2) for the classical formulation. All of the simulations were generated by a computer having an Intel Core™ i7 processor operating at 3.60 GHz, and with 16 GB of RAM.

### Example I

Dipole Antenna

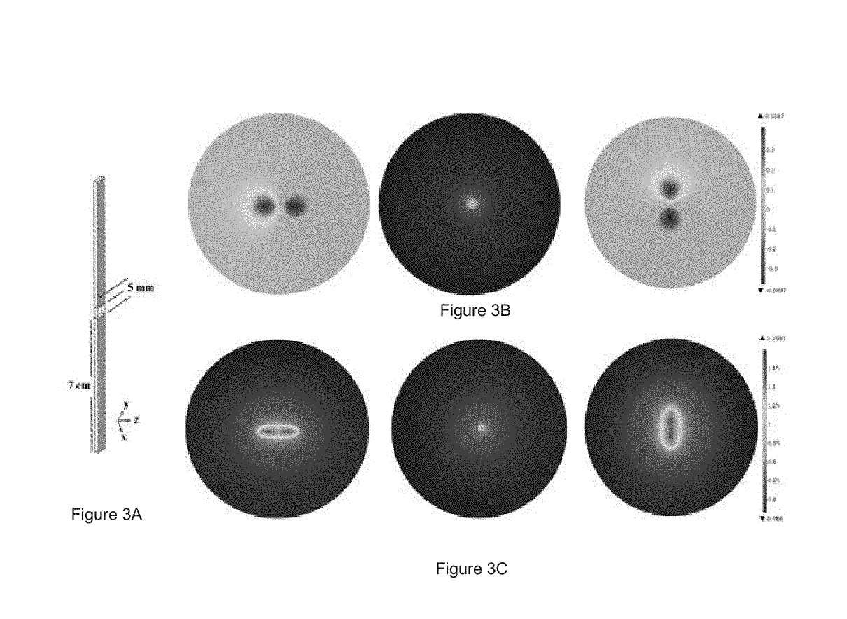

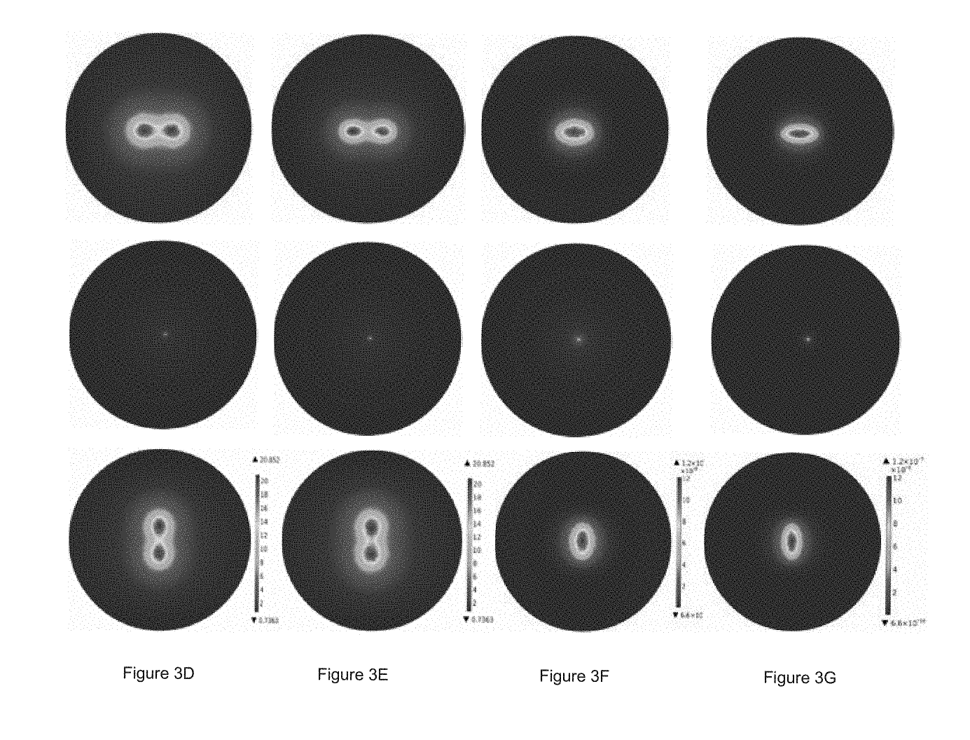

As shown in FIG. 3(a), a dipole antenna with arm dimension 7 cm×0.5 cm and a port size 0.5 cm×0.5 cm was operated in free space at a frequency of 1 GHz. The port impedance was 75 Ω in all the simulations, and the antenna surface was considered to be a perfect conductor.

FIGS. 3(b) and 3(c) respectively show the two simulated potentials v and ψ (which define the main fields) in the xy, yz, and zx planes. FIGS. 3(d) and 3(e) show (in the same three planes) the corresponding electric fields calculated by the classical approach (FIG. 3(d)) and by the 2-scalar formulation (FIG. 3(e)). The simulated magnetic flux density calculated by the classical method and by the two-scalar method are shown in FIGS. 3(f) and 3(g), respectively.

It is immediately apparent that the fields calculated by the pair-potential method agree very well with those obtained using the classical method (a quantitative comparison is described below). Slight differences are expected due to some physics-based optimizations of the RF Module that do not exist in the Mathematics Module.

### Example II

Dipole Antenna With Scatterer

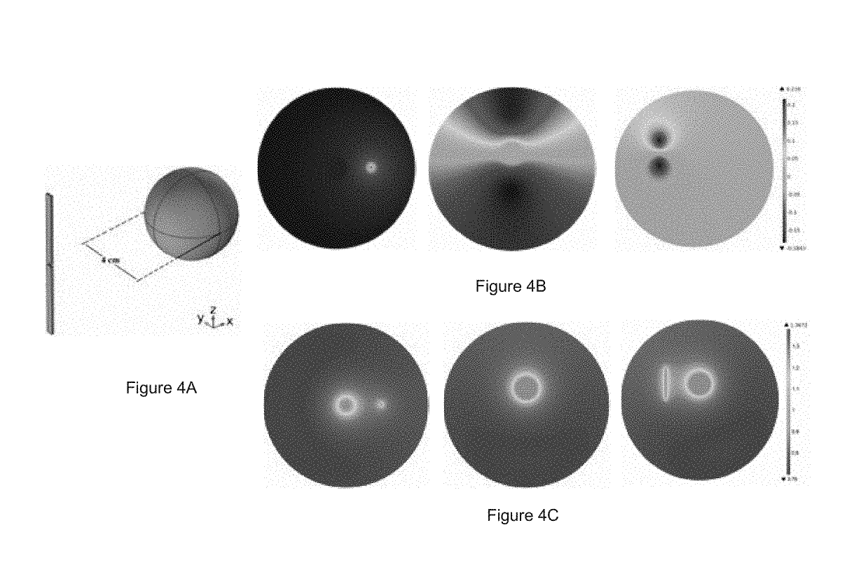

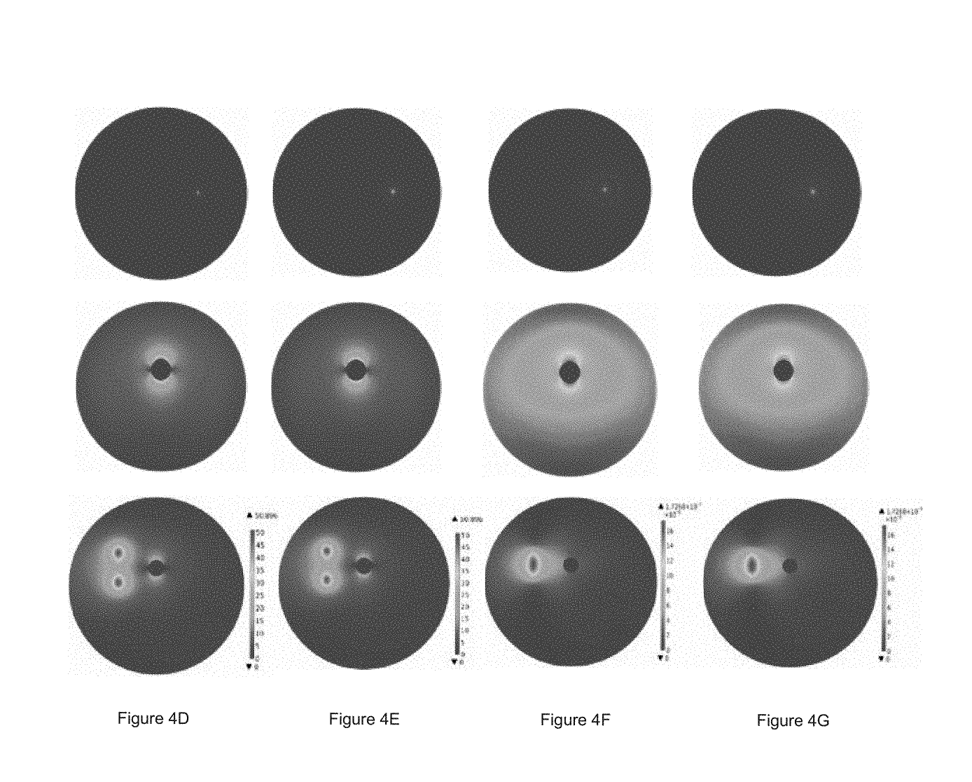

In a second example, a conducting sphere with a radius r=2 cm was placed in front of the dipole antenna of Example I, as shown in FIG. 4(a). The resulting scattering effects were simulated by both the classical and two-scalar methods. FIGS. 4(b) and 4(c) respectively show the two simulated potentials v and yr in the xy, yz, and zx planes. FIGS. 4(d) and 4€ show (in the same three planes) the corresponding electric fields calculated by the classical approach (FIG. 4(d)) and by the two-scalar formulation (FIG. 4(e)). The simulated magnetic flux density calculated by the classical method and by the two-scalar method are shown in FIGS. 4(f) and 4(g), respectively.

As with the first Example, the field distributions calculated by the two different methods are in good agreement, and once again the minor differences may originate from the different optimizations in the RF and Mathematics modules in COMSOL, as described above.

### Example III

Array of Dipole Antennas Around a Head Model

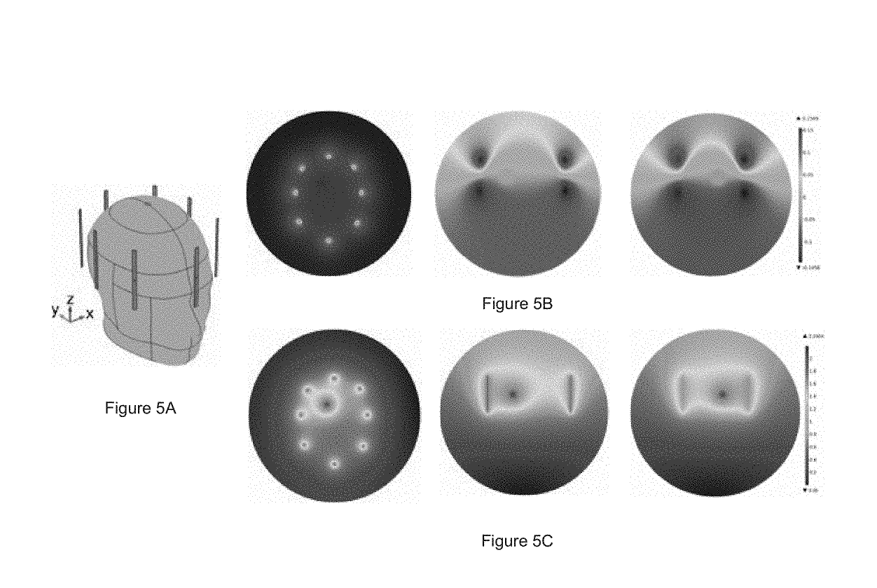

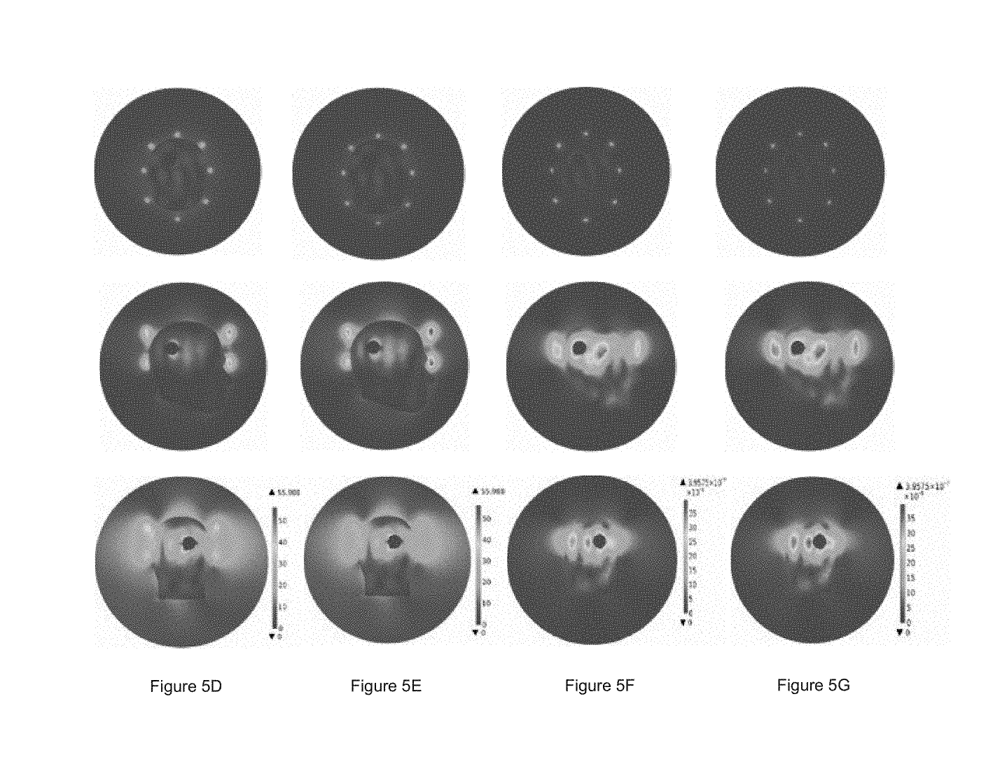

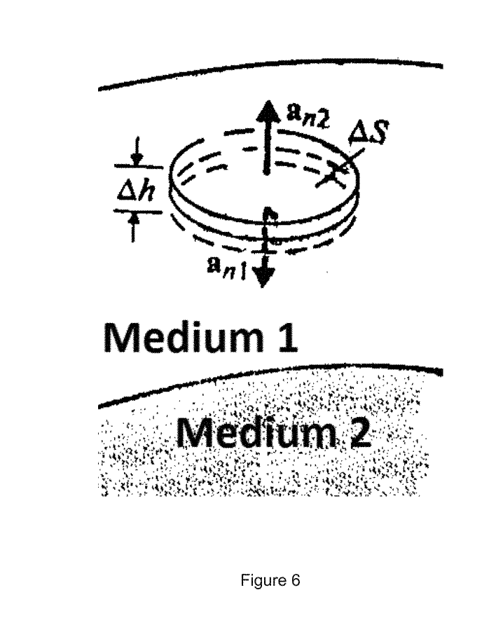

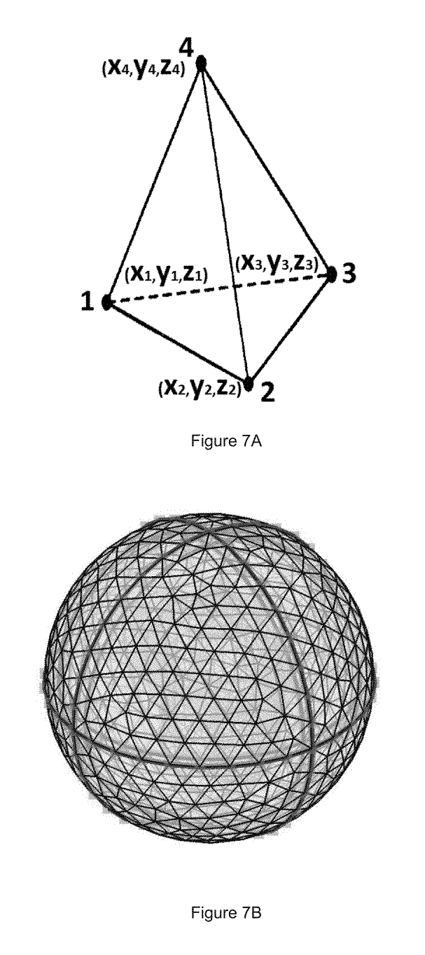

In a third Example, the dipole antenna described above was replicated to construct an elliptic array of 8 identical antennae. As shown in FIG. 5(a), this array was arranged to surround a realistically size and shaped model of a human head with average dielectric properties εᵣ=44.45, σ=0.94 (S/m). The head model includes the scatterer from the previous example as a conducting object embedded within the head and near the back side of the head. The purpose of this example was to demonstrate the ability of the two-scalar potential method to solving multilayer and complex geometry problems. All of the antennas simultaneously illuminated the head at a frequency of 1 GHz. FIGS. 5(b) to 5(g) show the spatial distributions of the scalar potentials, and FIGS. 5(d) to 5(g) show the spatial distributions of the electric fields (FIGS. 5(d) and (e)) and the magnetic flux density (FIGS. 5(f) and (g)), as calculated by the classical and two-scalar potential methods. At least qualitatively, the calculated spatial distributions of the electric and magnetic fields are clearly in agreement between the two methods.

A. Comparison

Equation (29) was used to quantify the minor differences between the results calculated by the classical and two-scalar methods, and the results are summarized in Table I below. It is apparent that the discrepancies are quite small, and it is considered that these can be attributed to the different optimization algorithms used in the different modules of COMSOL used by the two methods. For example, the inventors have experienced similarly minor discrepancies in solving a given problem using different computational software packages; e.g., HFSS, CST, COMSOL and ADS. The differences listed in Table I can be reduced to below 0.3×10⁻³, 2.61×10⁻³, and 3.21×10⁻³ for the dipole, dipole scatterer and head imaging examples, respectively, when using proper values for the truncating boundary radius, element discretization and number of meshes (for example increasing radius of the truncating sphere from 25 cm to 45 cm, using cubic instead of quadratic element discretization or using fine instead of normal meshing).

B. Computational Time Comparison

The computational times for the above examples using both the classical and 2-scalar methods are summarized in Table II below. As expected, reducing the number of potentials directly impacts the computational time. In every case the two-scalar potential method requires less computational time because it deals with solving two potential equations in the domain instead of solving the three equations of the main vector fields. This reduction in computational time is more significant in large-scale problems where the size of the matrix representation of the system of equations becomes larger (See Appendix III for more details). If the matrix size is M×M, the inversion time will be of the third order i.e. M³ (while some optimizations may reduce this order to M^{2.37}).

TABLE I
QUANTITATIVE COMPARISON FOR EXAMPLES IN SECTION
IV USING THE CLASSICAL AND 2-SCALAR APPROACHES

| | | dipole and | |
|---|---|---|---|
| | dipole antenna | scatterer | head imaging |
| Difference | 0.4 × 10⁻³ | 8.1 × 10⁻³ | 1.73 × 10⁻² |

The simulations in COMSOL Multiphysics include 3 × 10⁵ linear tetrahedral elements. The error definition is based on (29).

TABLE II
COMPUTATIONAL TIME COMPARISON FOR EXAMPLES IN
SECTION IV USING THE CLASSICAL AND 2-SCALAR
APPROACHES

| | | dipole and | |
|---|---|---|---|
| formulation | dipole antenna | scatterer | head imaging |
| classical | 20 sec | 31 sec | 182 sec |
| 2-scalar | 18 sec | 26 sec | 108 sec |

The simulations in COMSOL Multiphysics include 3 × 10⁵ linear tetrahedral elements.

Many modifications will be apparent to those skilled in the art without departing from the scope of the present invention.

### APPENDICES

### Appendix I: Normal Boundary Conditions

In order to prove the governing normal boundary conditions on scalar electric potential seen in (3b), two ways exist. The first one is to geometrically prove them applying the theorems in the calculus of differential and integral, and the second approach is to directly substitute the auxiliary potentials in the boundary conditions on the magnetic fields. To show the both methods, we derive the normal boundary conditions of v through the geometrical way, and that of A through the direct substitution.

To prove the normal derivative boundary condition of v, a small pillbox with its top face in medium 1 and its bottom face in medium 2 is considered as seen in FIG. 6. The upper and lower faces have an area ΔS, the height of this pillbox is Δh and its volume is V. Taking the volumetric integrals from the third Maxwell equation on the pillbox yields

$$∇ \cdot D = ρ \\ \to {\int }_{V} ( ∇ \cdot D ) dV = {\int }_{V} ( ρ ) dV \\ \to ɛ {\int }_{V} ( ∇ \cdot E ) dV = {\int }_{V} ( ρ ) dV \\ \to ɛ {\int }_{V} ( ∇ \cdot ( - ∇ v - j ω A ) ) dV = {\int }_{V} ( ρ ) dV \\ \to - ɛ {\int }_{V} ∇ \cdot ( ∇ v ) dV - j ωɛ {\int }_{V} ∇ \cdot AdV = {\int }_{V} ( ρ ) dV \qquad ( I .1 )$$

Using the Lorenz gauge condition in (13), we have

$$- ɛ {\int }_{V} ∇ \cdot ( ∇ v ) dV - {ω}^{2} {ɛ}^{2} μ {\int }_{V} vdV = {\int }_{V} ( ρ ) dV \qquad ( I .2 )$$

To study the behavior of the voltage near the boundaries, we let Δh to be vanishingly small. Thus, the second integral in the left-hand side will be a volume integral on a continuous function (v) for which the volume is going to zero (v→0). This integral is therefore zero. The remained terms of (I.2) are

$$- ɛ {\int }_{V \to 0} ∇ \cdot ( ∇ v ) dV = {\int }_{V \to 0} ( ρ ) dV \qquad ( I .3 )$$

Applying the divergence theorem, the volumetric integral in the left-hand side is divided into three surface integrals

$$- ɛ {\int }_{{S}_{1}} ∇ v . d {\vec{S}}_{1} - ɛ {\int }_{{S}_{2}} ∇ v . d {\vec{S}}_{2} - ɛ {\int }_{{S}_{3}} ∇ v . d {\vec{S}}_{3} = {\int }_{V \to 0} ( ρ ) dV \qquad ( I .4 )$$

where dS₁, dS₂, and dS₃ are the differential of the upper face, lower face and side face of the pillbox, respectively. Clearly, when Δh→0, the side integral vanishes. Also, it is obvious that dS₁=−dS₂=dS. Hence,

$${ɛ}_{1} {\int }_{S} ( ∇ v . {\vec{a}}_{n} ) dS - {ɛ}_{2} {\int }_{S} ( ∇ v . {\vec{a}}_{n} ) dS = {\int }_{V \to 0} ( ρ ) dV \qquad ( I .5 )$$

where \vec{a}ₙ is the normal vectors of dS₁. As the pillbox is small, (I.5) is identical to

$${ɛ}_{1} \frac{\partial {v}_{1}}{\partial n} Δ S - {ɛ}_{2} \frac{\partial {v}_{2}}{\partial n} Δ S = {\int }_{V \to 0} ( ρ ) dV \\ \to {ɛ}_{1} \frac{\partial {v}_{1}}{\partial n} - {ɛ}_{2} \frac{\partial {v}_{2}}{\partial n} = \frac{{\int }_{V \to 0} ( ρ ) dV}{Δ S} = {ρ}_{s} \\ \to {ɛ}_{r}^{-} \frac{\partial {v}^{-}}{\partial n} - {ɛ}_{r}^{+} \frac{\partial {v}^{+}}{\partial n} = \frac{{ρ}_{s}}{{ɛ}_{0}} \qquad ( I .6 )$$

which finishes the proof. Since ρₛ=0 on dielectrics, (I.6) reduces to the continuity condition in (3b).

In order to prove the boundary condition on magnetic vector potential \vec{A} in equation (3b), it is more straightforward to directly deal with the governing boundary condition on the tangential component of the magnetic field i.e.

\vec{a}ₙ×(H₁−H₂)=Jₛ (I.7)

Substituting the definition of B from equation (4) into equation (I.7), we get

$${\vec{a}}_{n} \times ( \frac{∇ \times {A}_{1}}{{μ}_{1}} - \frac{∇ \times {A}_{2}}{{μ}_{2}} ) = {J}_{s} \qquad ( I .8 )$$

Applying the BAC-CAB rule in vector calculus, equation (I.8) becomes

$$( \frac{∇ ( {A}_{1} . {\vec{a}}_{n} ) - ∇ . {\vec{a}}_{n} ( {A}_{1} )}{{μ}_{1}} - \frac{∇ ( {A}_{2} . {\vec{a}}_{n} ) - ∇ . {\vec{a}}_{2} ( {A}_{2} )}{{μ}_{2}} ) = {J}_{s} \qquad ( I .9 )$$

Therefore,

$$\frac{1}{{μ}_{r}^{-}} ( \frac{\partial {A}_{n}^{-}}{\partial i} - \frac{\partial {A}_{i}^{-}}{\partial n} ) - \frac{1}{{μ}_{r}^{+}} ( \frac{\partial {A}_{n}^{-}}{\partial i} - \frac{\partial {A}_{i}^{+}}{\partial n} ) = {μ}_{0} {J}_{s} \qquad ( I .10 )$$

which finishes the proof. On the dielectric surfaces where Jₛ=0, (I.10) reduces to the continuity condition in equation (3b).

### Appendix II: Determining the Value of γ

In order to find γ, the general solution of Equation (18) in Cartesian coordinates is considered (the same approach is valid for the other orthogonal coordinate systems). According to the standard method known to those skilled in the art as “separation of variables”, either φ or ψ is written as the product of three functions of one coordinate each (the coordinate variables are “separated”) as:

ψ(x, y, z)=Ψₓ(x)Ψ_{y}(y)Ψ_{z}(z)

φ(x, y, z)=Φₓ(x)Φ_{y}(y)Φ_{z}(z) (II.1)

Substituting (I.1) in Equations (18) yields

$$\{ \begin{matrix}\frac{{d}^{2} {Ψ}_{x}}{{dx}^{2}} + ( {k}_{x}^{2} + {γ}_{x}^{2} ) {Ψ}_{x} = 0 \\ \frac{{d}^{2} {Ψ}_{x}}{{dy}^{2}} + ( {k}_{y}^{2} + {γ}_{y}^{2} ) {Ψ}_{y} = 0 \\ \frac{{d}^{2} {Ψ}_{z}}{{dz}^{2}} + ( {k}_{z}^{2} + {γ}_{z}^{2} ) {Ψ}_{z} = 0\end{matrix} , \{ \begin{matrix}\frac{{d}^{2} {Φ}_{x}}{{dx}^{2}} + {γ}_{x}^{2} {Φ}_{x} = 0 \\ \frac{{d}^{2} {Φ}_{y}}{{dy}^{2}} + {γ}_{y}^{2} {Φ}_{y} = 0 \\ \frac{{d}^{2} {Φ}_{z}}{{dz}^{2}} + {γ}_{z}^{2} {Φ}_{z} = 0\end{matrix} \qquad ( II .2 )$$

where the following relation between the separation parameters ((kₓ, γₓ), (k_{y}, γ_{y}), (k_{z}, γ_{z})) must hold:

$$( {k}_{x}^{2} + {γ}_{x}^{2} ) + ( {k}_{y}^{2} + {γ}_{y}^{2} ) + ( {k}_{z}^{2} + {γ}_{z}^{2} ) = {k}^{2} + {γ}^{2} \\ \to \{ \begin{matrix}{k}_{x}^{2} + {k}_{y}^{2} + {k}_{z}^{2} = {k}^{2} \\ {γ}_{x}^{2} + {γ}_{y}^{2} + {γ}_{z}^{2} = {γ}^{2}\end{matrix} \qquad ( II .3 )$$

As (II.2) shows, the separated equations are in the same form. Thus, they are usually called “harmonic equations”. In general, the solution to each of these harmonic equations is expressed by harmonic functions h_{Ψ}, h_{Φ}, as:

$$\{ \begin{matrix}{Ψ}_{x} = {h}_{Ψ} ( \sqrt{{k}_{x}^{2} + {γ}_{x}^{2}} x ) \\ {Ψ}_{y} = {h}_{Ψ} ( \sqrt{{k}_{y}^{2} + {γ}_{y}^{2}} y ) \\ {Ψ}_{z} = {h}_{Ψ} ( \sqrt{{k}_{z}^{2} + {γ}_{z}^{2}} z )\end{matrix} , \{ \begin{matrix}{Φ}_{x} = {h}_{Φ} ( {γ}_{x} x ) \\ {Φ}_{y} = {h}_{Φ} ( {γ}_{y} y ) \\ {Φ}_{z} = {h}_{Φ} ( {γ}_{z} z )\end{matrix} \qquad ( II .4 )$$

Regarding the nature of the problem, these harmonic functions are of the following forms (e.g. for x-direction):

$${h}_{Ψ} ( \sqrt{{k}_{x}^{2} + {γ}_{x}^{2}} x ) ∼ \{ \begin{matrix}sin ( \sqrt{{k}_{x}^{2} + {γ}_{x}^{2}} x ) \\ cos ( \sqrt{{k}_{x}^{2} + {γ}_{x}^{2}} x ) \\ {e}^{\pm \sqrt{{k}_{x}^{2} + {γ}_{x}^{2}} x} \end{matrix} \\ {h}_{} ( {γ}_{x} x ) ∼ \{ \begin{matrix}sin ( {γ}_{x} x ) \\ cos ( {γ}_{x} x ) \\ {e}^{\pm j {γ}_{x} x} \end{matrix} \qquad ( II .5 )$$

Substituting (II.5) in (II.1), one of the solutions for Equation (18) (referred to as the “elementary wave function”) is:

ψₙ=h_{Ψ}(\sqrt{kₓ²+γₓ²}x)h_{Ψ}(\sqrt{k_{y}²+γ_{y}²}y)h_{Ψ}(\sqrt{k_{z}²+γ_{z}²}z)

φₙ=h_{Φ}(γₓx)h_{Φ}(γ_{y}y)h_{Φ}(γ_{z}z) (II.6)

However, as any two of these solutions are linearly independent (as per (II.3), among the three separation parameters (kₓ, k_{y}, k_{z}) or (γₓ, γ_{y}, γ_{z}), only two of them are independent), the general solution to Equation (18) is the linear combination of (II.6) on the two independent functions (say (kₓ,k_{y}) or (γₓ, γ_{y})) as

$$ψ = {\sum }_{\sqrt{{k}_{x}^{2} + {γ}_{x}^{2}}} {\sum }_{\sqrt{{k}_{y}^{2} + {γ}_{y}^{2}}} {C}_{1} {ψ}_{n} \\ ϕ = {\sum }_{{γ}_{x}} {\sum }_{{γ}_{y}} {C}_{2} {ϕ}_{n} \qquad ( II .6 )$$

where C₁ and C₂ are two constants.

According to either Equation (10) or Equation (16), and depending on the boundary conditions of the problem, a specific form of the multiplication of φ and ψ in (II.5) gives the electric field or magnetic flux density. Consequently, the argument of any type of this multiplication must be (kₓ, k_{y}, k_{z}). In other words, the following general equation must be satisfied:

±γₓ±\sqrt{kₓ²+γₓ²}=±kₓ

±γ_{y}±\sqrt{k_{y}²+γ_{y}²}=±k_{y}

±γ_{z}±\sqrt{k_{z}²+γ_{z}²}=±k_{z} (II.3)

Solving the above equation for (γₓ, γ_{y}, γ_{z}) yields:

$$2 {k}_{x} {γ}_{x} = 0 \\ 2 {k}_{y} {γ}_{y} = 0 \\ 2 {k}_{z} {γ}_{z} = 0 \\ \to \{ \begin{matrix}( {γ}_{x} , {γ}_{y} , {γ}_{z} ) = 0 \\ or \\ ( {k}_{x} , {k}_{y} , {k}_{z} ) = 0 , this solution violates \\ the wave theory which requires k \neq 0.\end{matrix} \qquad ( II .4 )$$

Thus, the only possible choice is (γₓ, γ_{y}, γ_{z})=0. This analysis also reveals the time-varying nature of ψ and the static nature of φ.

### Appendix III: Numerical Aspects in FEM

In order to solve the equations (18) via a FEM formulation, the corresponding integral representation of these partial differential equations (PDEs) are derived. This integral representation is called the functional of the PDE. As a general form, equation (28a) can be re-written as:

−∇²u+β²u=0 (III.1)

where u is the scalar function i.e. v or ψ (as the two potentials to be solved) and β is −k².

The functional of equation (III.1) is derived as

$$F ( u ) = \frac{1}{2} {\int \int \int }_{V} ( ∇ u . ∇ u + β {u}^{2} ) dV + \underbrace{\frac{1}{2} {\int \int }_{S} η {u}^{2} dS}_{contributes only on S} \qquad ( III .2 )$$

where V is the 3D volume of the problem domain and S is the surface on which the third kind boundary conditions are applied (e.g. the dielectric interfaces or the surrounding surface). According to the third kind boundary conditions, η=h, q or w. The linear tetrahedral element seen in FIG. 7(a) contains 4 nodes and is used in FEM as a typical element to discretize the problem domain. The value of the unknown function u is approximated at each linear tetrahedral element by

$${u}_{m} = {\sum }_{i = 1}^{4} {N}_{i}^{m} {u}_{i}^{m} \qquad ( III .3 )$$

Where N is called the interpolation function and u^{m}ᵢ is the value of the unknown function at ith node of the mth element. The interpolation function for linear tetrahedral is given as

$${N}_{i}^{m} = \frac{1}{6 Γ} ( {a}_{i}^{m} + {b}_{i}^{m} x + {c}_{i}^{m} y + {d}_{i}^{m} z ) \qquad ( III .4 )$$

for which the coefficients are

$${a}_{i}^{m} = \frac{1}{6 Γ} \vert \begin{matrix}{u}_{1}^{m} & {u}_{2}^{m} & {u}_{3}^{m} & {u}_{4}^{m} \\ {x}_{1}^{m} & {x}_{2}^{m} & {x}_{3}^{m} & {x}_{4}^{m} \\ {y}_{1}^{m} & {y}_{2}^{m} & {y}_{3}^{m} & {y}_{4}^{m} \\ {z}_{1}^{m} & {z}_{2}^{m} & {z}_{3}^{m} & {z}_{4}^{m}\end{matrix} \vert ; {b}_{i}^{m} = \frac{1}{6 Γ} \vert \begin{matrix}1 & 1 & 1 & 1 \\ {u}_{1}^{m} & {u}_{2}^{m} & {u}_{3}^{m} & {u}_{4}^{m} \\ {y}_{1}^{m} & {y}_{2}^{m} & {y}_{3}^{m} & {y}_{4}^{m} \\ {z}_{1}^{m} & {z}_{2}^{m} & {z}_{3}^{m} & {z}_{4}^{m}\end{matrix} \vert \\ {c}_{i}^{m} = \frac{1}{6 Γ} \vert \begin{matrix}1 & 1 & 1 & 1 \\ {x}_{1}^{m} & {x}_{2}^{m} & {x}_{3}^{m} & {x}_{4}^{m} \\ {u}_{1}^{m} & {u}_{2}^{m} & {u}_{3}^{m} & {u}_{4}^{m} \\ {z}_{1}^{m} & {z}_{2}^{m} & {z}_{3}^{m} & {z}_{4}^{m}\end{matrix} \vert ; {d}_{i}^{m} = \frac{1}{6 Γ} \vert \begin{matrix}1 & 1 & 1 & 1 \\ {x}_{1}^{m} & {x}_{2}^{m} & {x}_{3}^{m} & {x}_{4}^{m} \\ {y}_{1}^{m} & {y}_{2}^{m} & {y}_{3}^{m} & {y}_{4}^{m} \\ {u}_{1}^{m} & {u}_{2}^{m} & {u}_{3}^{m} & {u}_{4}^{m}\end{matrix} \vert \\ Γ = \frac{1}{6} \vert \begin{matrix}1 & 1 & 1 & 1 \\ {x}_{1}^{m} & {x}_{2}^{m} & {x}_{3}^{m} & {x}_{4}^{m} \\ {y}_{1}^{m} & {y}_{2}^{m} & {y}_{3}^{m} & {y}_{4}^{m} \\ {z}_{1}^{m} & {z}_{2}^{m} & {z}_{3}^{m} & {z}_{4}^{m}\end{matrix} \vert \qquad ( III .5 )$$

where (xᵢ^{m}, yᵢ^{m}, zᵢ^{m}) are the coordinates of ith node at mth element. Substituting (III.3) in (III.2) for each element yields the functional at each element called F^{m}. The Ritz method in variational principle says that the extremum point of F^{m} with respect to u^{m}ᵢ is the solution of (III.1) at each element. Thus, to find the extremum points, the derivate of F^{m} with respect to u^{m}ᵢ is equated to zero at each element and the corresponding roots are found as the solution. It reads

$$\frac{\partial F ( {u}_{i}^{m} )}{\partial {u}_{i}^{m}} = {\sum }_{j = 1}^{4} {u}_{j}^{m} {\int \int \int }_{{V}^{m}} ( ∇ {N}_{i}^{m} . ∇ {N}_{j}^{m} + β {N}_{i}^{m} {N}_{j}^{m} ) dV + \underbrace{{\sum }_{j = 1}^{3} {u}_{j}^{m} {\int \int }_{{S}^{m}} η {N}_{i}^{m} {N}_{j}^{m} dS}_{contributes only on S} = 0 \qquad ( III .6 )$$

After writing equation (III.6) in a matrix form which gives the linear system of equations, we have

K_{4×4}U_{4×1}=O_{4×1} (III.7)

where K and O are the coefficient and excitation matrices, respectively, and U is the matrix of unknowns. Their corresponding elements are

$${K}_{ij}^{m} = {\int \int \int }_{{V}^{m}} ( ∇ {N}_{i}^{m} . ∇ {N}_{j}^{m} + β {N}_{i}^{m} {N}_{j}^{m} ) dV + \underbrace{{\int \int }_{{S}^{m}} η {N}_{i}^{m} {N}_{j}^{m} dS}_{contributes only on S} \\ {O}_{ij}^{m} = 0 ( except the Dirichlet condition ) \qquad ( III .8 )$$

The Galerkin's method is another technique to reach above results, but as it coincides with the Ritz method in equation (III.7) or (III.8), we exclude the discussion on this method.

As (III.3) is continuous, the continuity conditions in equations (23b) are satisfied automatically (u⁺=u⁻). Moreover, the continuity conditions on normal and tangential component is automatically satisfied splitting the domain to subdomains where constitutive parameters (permittivity and permeability) are continuous. Also, the surface integral in (III.2) includes the contribution of the third kind boundary conditions. Hence, the only remained condition to apply is the Dirichlet boundary condition. To incorporate this condition on ith node, the following change in the corresponding matrix element of either K or O is necessary.

Kᵢᵢ^{m}=a very large number, (say 10⁷⁰ as per [6])

Oᵢᵢ^{m}=f×(the above very large number) (III.8)

When the system of equations is derived for each element, they are assembled (as seen in FIG. 7(b)) and the global system of equations given bellow

U_{M×1}=(K_{M×M})⁻¹O_{M×1} (III.9)

is the solution of (III.1) where M is the total number of elements (3×10⁵ in our calculations). This is the general approach by which FEM solves (III.1).

### Appendix IV: Determining the Eigenvalue

In order to find the eigenvalue, the general forms of time-harmonic electromagnetic waves are considered. The general travelling, one-sided evanescent, or attenuated travelling solutions (according to the different values of γ and \sqrt{2k²−γ²}) for the pair-potentials described by (33) are:

$$ψ = {C}_{0} {e}^{- j \sqrt{2 {k}^{2} - {γ}^{2}} r} + {C}_{1} {e}^{+ j \sqrt{2 {k}^{2} - {γ}^{2}} r} \\ ϕ = {C}_{2} {e}^{- γ r} + {C}_{3} {e}^{+ γ r} \qquad ( IV .1 )$$

The general standing, two-sided evanescent, or localized standing solutions (according to different values of γ and \sqrt{2k²−γ²} for the pair-potentials described by (33) are:

ψ=C′₀ sin\sqrt{2k²−γ²}r)+C′₁ cos(\sqrt{2k²−γ²}r)

φ=C′₂ sinh(γr)+C′₃ cosh(γr) (IV.2)

where Cᵢ and C′ᵢ are functions of space coordinates.

According to either (5) or (31), the multiplication of φ and ψ in either (IV.1) or (IV.2) gives the electric field or magnetic flux density. Consequently, this multiplication must have a wave number equal to jk. Hence, the following general equation must be satisfied

±γ±j\sqrt{2k²−γ²}=±jk

→±j\sqrt{2k²−γ²}=±jk∓γ (IV.3)

where the left hand side of above equation is seen in the argument of the multiplication of φ and ψ in either (IV.1) or (IV.2). Solving above equation for γ yields

$${( \pm j \sqrt{2 {k}^{2} - {γ}^{2}} )}^{2} = {( \pm jk \overline{+} γ )}^{2} = {( jk - γ )}^{2} \\ \to - 2 {k}^{2} + {γ}^{2} = - {k}^{2} + {γ}^{2} - 2 jk γ \\ \to {k}^{2} - 2 jk γ = 0 \\ \to k ( k - 2 j γ ) = 0 \\ \to \{ \begin{matrix}γ = - \frac{j}{2} k \\ or \\ k = 0 , this solution is in contradiction \\ with wave theory requiring k \neq 0. \end{matrix} \qquad ( IV .4 )$$

Thus, the only possible choice is

$$γ = - \frac{j}{2} k .$$

1. A computational electromagnetics process for determining electromagnetic fields, the process being executed by at least one processor of a data processing system, and including the steps of:
(i) solving a pair of differential equations for only two variables, the two variables representing a pair of scalar potentials; and
(ii) determining at least one of an electric field and a magnetic field from the pair of scalar potentials determined at step (i).

2. The computational electromagnetics process of claim 1, wherein step (ii) includes at least one of:
(i) determining the electric field \vec{E} according to:
\vec{E}=jωψ∇φ; and
(ii) determining the magnetic field \vec{B} according to:
\vec{B}=∇φ×∇ψ;
where φ and ψ represent the scalar potentials, ω represents angular frequency, and j=\sqrt{−1}.

3. The computational electromagnetics process of claim 1, wherein the differential equations are of the form:
∇²ψ+k²ψ=0
∇²φ=0
where k=ω\sqrt{εμ} is the wavenumber, ε represents permittivity, and μ represents permeability.

4. The computational electromagnetics process of claim 1, wherein the differential equations are of the form:
∇²ψ+k²ψ=0
∇²v+k²v=0
where k=ω\sqrt{εμ} is the wavenumber, ε represents permittivity, μ represents permeability, and v represents scalar electric potential, and wherein
$$v = - \frac{j ωϕψ}{2} .$$

5. The computational electromagnetics process of claim 1, wherein the differential equations are of the form:
$${∇}^{2} ψ + ( 2 {k}^{2} - {γ}^{2} ) ψ = 0$$
$${∇}^{2} ϕ - {γ}^{2} ϕ = 0$$
$$or$$
$${∇}^{2} ψ + ( 2 {k}^{2} - {γ}^{2} ) ψ = 0$$
$${∇}^{2} v + {k}^{2} v = - \frac{ρ + {ρ}_{j}}{ɛ}$$
where φ and ψ represent the scalar potentials,
$$γ = - \frac{j}{2} k ,$$
k=ω\sqrt{εμ} is the wavenumber, ε represents permittivity, μ represents permeability, v represents scalar electric potential, and v=−jωφψ.

6. A computational electromagnetics process executed by at least one processor of a data processing system, the process including at least one of:
(i) determining an electric field \vec{E} according to:
\vec{E}=jωψ∇φ; and
(ii) determining a magnetic field \vec{B} according to:
\vec{B}=∇φ×∇ψ;
where ω represents angular frequency, j=\sqrt{−1}, and φ and ψ represent scalar potentials satisfying a pair of differential equations for only two variables, the two variables representing the scalar potentials.

7. The computational electromagnetics process of claim 6, wherein the pair of differential equations are of the form:
∇²ψ+k²ψ=0
∇²φ=0
where k=ω\sqrt{εμ} is the wavenumber, ε represents permittivity, and μ represents permeability.

8. The computational electromagnetics process of claim 6, wherein the pair of differential equations are of the form:
∇²ψ+k²ψ=0
∇²v+k²v=0
where k=ω\sqrt{εμ} is the wavenumber, ε represents permittivity, μ represents permeability, and v represents scalar electric potential, and wherein
$$v = - \frac{j ωϕψ}{2} .$$

9. The computational electromagnetics process of claim 6, wherein the pair of differential equations are of the form:
$${∇}^{2} ψ + ( 2 {k}^{2} - {γ}^{2} ) ψ = 0$$
$${∇}^{2} ϕ - {γ}^{2} ϕ = 0$$
$$or$$
$${∇}^{2} ψ + ( 2 {k}^{2} - {γ}^{2} ) ψ = 0$$
$${∇}^{2} v + {k}^{2} v = - \frac{ρ + {ρ}_{j}}{ɛ}$$
where k=ω\sqrt{εμ} is the wavenumber,
$$γ = - \frac{j}{2} k ,$$
ε represents permittivity, μ represents permeability, v represents scalar electric potential, and v=−jωφψ.

10. At least one computer-readable storage medium having stored thereon executable instructions that, when executed by at least one processor of a data processing system, cause the at least one processor to execute the computational electromagnetics process of claim 1.

11. At least one computer-readable storage medium having stored thereon executable instructions that, when executed by at least one processor of a data processing system, cause the at least one processor to execute a computational electromagnetics process, including the steps of:
(i) solving a pair of differential equations for only two variables, the two variables representing a pair of scalar potentials; and
(ii) determining at least one of an electric field and a magnetic field from the pair of scalar potentials determined at step (i).

12. The at least one computer-readable storage medium of claim 11, wherein step (ii) includes at least one of:
(iii) determining the electric field \vec{E} according to:
\vec{E}=jωψ∇φ; and
(iv) determining the magnetic field \vec{B} according to:
\vec{B}=∇φ×∇ψ;
where φ and ψ represent the scalar potentials, ω represents angular frequency, and j=\sqrt{−1}.

13. The at least one computer-readable storage medium of claim 11, wherein the differential equations are of the form:
∇²ψ+k²ψ=0
∇²φ=0
where k=ω\sqrt{εμ} is the wavenumber, ε represents permittivity, and μ represents permeability.

14. The at least one computer-readable storage medium of claim 11, wherein the differential equations are of the form:
∇²ψ+k²ψ=0
∇²v+k²v=0
where k=ω\sqrt{εμ} is the wavenumber, ε represents permittivity, μ represents permeability, and v represents scalar electric potential, and wherein
$$v = - \frac{j ωϕψ}{2} .$$

15. The at least one computer-readable storage medium of claim 11, wherein the differential equations are of the form:
$${∇}^{2} ψ + ( 2 {k}^{2} - {γ}^{2} ) ψ = 0$$
$${∇}^{2} ϕ - {γ}^{2} ϕ = 0$$
$$or$$
$${∇}^{2} ψ + ( 2 {k}^{2} - {γ}^{2} ) ψ = 0$$
$${∇}^{2} v + {k}^{2} v = - \frac{ρ + {ρ}_{j}}{ɛ}$$
where φ and ψ represent the scalar potentials,
$$γ = - \frac{j}{2} k ,$$
k=ω\sqrt{εμ} is the wavenumber, ε represents permittivity, μ represents permeability, v represents scalar electric potential, and v=−jωφψ.

16. A computational electromagnetics system having a memory and at least one processor configured to execute a computational electromagnetics process, including the steps of:
(i) solving a pair of differential equations for only two variables, the two variables representing a pair of scalar potentials; and
(ii) determining at least one of an electric field and a magnetic field from the pair of scalar potentials determined at step (i).

17. The computational electromagnetics system of claim 16, wherein step (ii) includes at least one of:
(iii) determining the electric field \vec{E} according to:
\vec{E}=jωψ∇φ; and
(iv) determining the magnetic field \vec{B} according to:
\vec{B}=∇φ×∇ψ;
where φ and ψ represent the scalar potentials, ω represents angular frequency, and j=\sqrt{−1}.

18. The computational electromagnetics system of claim 16, wherein the differential equations are of the form:
∇²ψ+k²ψ=0
∇²φ=0
where k=ω\sqrt{εμ} is the wavenumber, ε represents permittivity, and μ represents permeability.

19. The computational electromagnetics system of claim 16, wherein the differential equations are of the form:
∇²ψ+k²ψ=0
∇²v+k²v=0
where k=ω\sqrt{εμ} is the wavenumber, ε represents permittivity, μ represents permeability, and v represents scalar electric potential, and wherein
$$v = - \frac{j ωϕψ}{2} .$$

20. The computational electromagnetics system of claim 16, wherein the differential equations are of the form:
$$γ = - \frac{j}{2} k ,$$
where φ and ψ represent the scalar potentials,
$${∇}^{2} ψ + ( 2 {k}^{2} - {γ}^{2} ) ψ = 0$$
$${∇}^{2} ϕ - {γ}^{2} ϕ = 0$$
$$or$$
$${∇}^{2} ψ + ( 2 {k}^{2} - {γ}^{2} ) ψ = 0$$
$${∇}^{2} v + {k}^{2} v = - \frac{ρ + {ρ}_{j}}{ɛ}$$
k=ω\sqrt{εμ} is the wavenumber, ε represents permittivity, μ represents permeability, v represents scalar electric potential, and v=−jωφψ.
